(19) United States
(12) Patent Application Publication
(10) Pub. No.: US 2025/0118164 A1
(43) Pub. Date: Apr. 10, 2025

(54) ELECTRONIC GAMING SYSTEM FOR PLAYING GAMES WITH DICE

(71) Applicant: Generation Z, LLC, Columbus, MN (US)

(72) Inventors: Stephen Deckoff, Columbus, MN (US); Joshua Gago, Rice Lake, WI (US); Jason Nordby, North St. Paul, MN (US); Lynnette Blom, Brook Park, MN (US)

(21) Appl. No.: 18/905,907

(22) Filed: Oct. 3, 2024

Related U.S. Application Data
(60) Provisional application No. 63/588,152, filed on Oct. 5, 2023.

(51) Int. Cl. G07F 17/32

(52) U.S. Cl. CPC G07F 17/3267; G07F 17/3211; G07F 17/3225; G07F 17/3272; G07F 17/3293

(57) ABSTRACT

Disclosed herein is an electronic gaming system using common playing cards including: player computing devices that provide individualized gaming interfaces for players and a gaming computing device that can: based on sets of playing cards with one set being dealt successive to another set, continuously identify the sets, based on a request to start a game from at least one device, identify first and second sets of playing cards, identify, among the first set, a first card having a card value that is mapped, based on mapping data, to a first dice value, identify, among the second set, a second card having a value that is mapped to a second dice value, transmit, to the device, data representative of the cards and respective dice values, and determine a game outcome based on applying a gaming rule to a summation of the first and second dice values.

### INCORPORATION BY REFERENCE

This application claims the benefit of priority of U.S. Provisional Patent Application No. 63/588,152, filed Oct. 5, 2023, the entirety of which is incorporated by reference herein.

### TECHNICAL FIELD

This document generally describes devices, systems, and methods related to electronic gaming systems that provide electronic gaming, such as craps gaming, using playing cards, such as physical playing cards.

### BACKGROUND

Electronic gaming systems and devices have traditionally relied on random number generators to determine gaming outcomes that are displayed to players as part of the game. Additionally, electronic gaming systems receive player inputs based on the displayed gaming outcomes. For example, while a number of variations exist, electronic gaming devices typically deal a number of cards or roll multiple dice based on the type of game being played. An outcome of the game (e.g., whether the player won and the odds that apply to the win) may be determined based on a final resulting hand of the player or final resulting values of the rolled dice. The player's cards and game outcome(s) can be determined by the electronic gaming devices using random number generators that are implemented by the electronic gaming devices. Players can play different games but can receive same sets of cards and/or dice values as other players who play different games. The players can also play at different paces relative to each other.

Moreover, craps is a game of skill with a large number of variations, including variations in format of gameplay, player actions (e.g., betting), and determination of gaming outcomes. For example, in a game of craps, players place bets on a craps table as a shooter (a person at the table, such as a dealer or another player) rolls 2 dice. The goal is to roll a number or point with the 2 dice and then roll that same number again before a number of 7 is rolled. The number can be 4, 5, 6, 8, 9, or 10. The number that the shooter is trying to roll again before a 7 is marked on the craps table with a puck. If that number is made then the puck is removed from the table and the shooter shoots again, which is called a “come out roll,” meaning that it is the beginning of a new game and a new number or point has not yet been established. If a 7 is rolled before the established number for the game, then it is a called a “seven out,” in which the game ends and the shooter loses control of the 2 dice. The dice are then handed to a next shooter at the craps table, who repeats the process described above.

In a game of craps, players can place a variety of bets on the craps table. Some of the bets include pass line, place bets, hard ways, and craps & 11. As an example, in pass line bets, players bet that on a first roll, 7 or 11 rolls to win, 2, 3, or 12 loses. In don't pass bets, players bet that on a first roll, 2 or 3 wins, 12 is a push, and 7 or 11 looses. As another example, come bets have the same rules as pass line bets and don't come bets have the same rules as don't pass bets. In field bets (e.g., “one roll bet”), if any number in a field box on the craps table comes out, the player placing the bet wins. Place bets are wagers made on 4, 5, 6, 8, 9, or 10, and are “off” on the come-out roll unless the player indicates otherwise. Moreover, proposition bets are one roll bets that the number will be 2, 3, 7, 11, or 12. One or more other bets and wagers can also be placed in a game of craps.

### SUMMARY

The document generally describes electronic gaming systems. More particularly, this document describes electronic gaming techniques for games with dice (e.g., craps games) based on physical cards (e.g., playing cards) dealt at a physical gaming table. The electronic gaming techniques described herein can deal common cards for accommodating multiple players who play the games at different timings and/or paces. For example, sets of cards can be continuously dealt at a physical gaming table (for example by a dealer) at a relatively fast rate or a desired rate. While being continuously dealt, each set of cards can be identified and associated with values that correspond to a particular type of game played by each of multiple players. As an illustrative example, in games involving dice (e.g., craps), one or more of the dealt cards can be selected, identified for being mapped to dice values, and then presented to the players with the mapped dice value(s). In card games (e.g., five-card draw poker), one or more of the dealt cards can simply be selected and presented to the players and used for a particular stage of a game being currently played by each of the players. In games involving wheels (e.g., roulette), one or more of the dealt cards can be selected, identified for being mapped to predetermined wheel values, and then presented to the players with the mapped wheel value(s). As a result, each player can play one or more different or same games as other players at their preferred pace, without being affected by paces, play stages, or gaming selections of the other players at the physical gaming table or other players that are remote from the physical gaming table but also playing games using the cards that are being continuously dealt.

In general, a game of craps traditionally involves players placing bets on a craps table while another player, or dealer, at the table rolls 2 dice and tries to roll a particular number before rolling a 7. Card-based electronic gaming systems described herein can be programmed to continuously deal common cards used by all players playing at the particular table, including players who are playing virtually or otherwise remote from the particular table, and convert card values to dice numbers using mapping data. Instead of using traditional dice, card-based electronic gaming systems can match card values to 6 possible numbers that a dice can roll as. In mapping data, one or more cards in a standard 52-card deck can be considered non-value cards and the remaining cards in the deck can be assigned or mapped to dice values. As an illustrative example, all Kings can be considered non-value cards, Ace-6 can be mapped to numbers 1-6, and 7-Queen can also be mapped to numbers 1-6. One or more other rules and/or mappings can be established and used to convert card values to dice values. Moreover, to keep the odds from being skewed, a shuffle of cards can be performed between dealing each set of cards. On a continuous shuffler using sets of 5 cards, for example, one dice roll value can be determined per set of 5 cards that are dealt. To mimic the effect of rolling 2 dice, a first set of dealt cards can be used to determine a first dice value and a second set of dealt cards can be used to determine a second dice value. The second set can be dealt immediately after the first set and/or within a threshold amount of time of the first set being dealt. A first card in a card sequence of the first set of cards that is mapped to a dice value can be identified and a first card in a card sequence of the second set of cards that is mapped to a dice value can also be identified. Sometimes, any cards in the sets that are not mapped to dice values may be discarded from the sets. The discarded cards may not be dealt in subsequent sets. However in some implementations, the discarded cards can be dealt in subsequent sets of cards. The identified cards with their corresponding dice values can then be presented at each computing device of each player playing the game. Gaming outcomes and payout can be automatically determined by the gaming system and based on the dice values, bets placed by the players, and craps gaming rules.

Moreover, the continuously dealt common cards can be used not only for players playing craps, but also for players playing a variety of other games, such as poker, baccarat, and roulette. Card-based electronic gaming systems for craps can also be programmed to allow the players at the table (and remote from the table) to play craps and other games at their desired paces, without having to rely on timing of other players playing the game. For instance, in one example of a craps game provided with common cards via a dealer-assist electronic gaming system, a dealer can physically deal five cards (e.g., scan five physical cards from a deck/shoe of cards). For players who start the game and place their bets at a first time, the system reads and identifies a first set of cards that was dealt at the first time and then a second set of cards that was dealt immediately after the first time (e.g., at a second time) to determine dice values and game outcomes for the players playing at the first time. For players who start the game at a second time, the system may identify the same second set of cards that are dealt at the second time in addition to a third set of cards that was dealt immediately after the first time (e.g., at a third time) to determine dice values and game outcomes for the players playing at the second time. In this example, the same second set of cards can be used for both groups of players, even though they are playing the game at different times. In some implementations, each group of players may receive dice values from cards that were drawn in different sets of cards at different times.

In addition to a main game (e.g., craps) being played, the sets of cards being continuously dealt and used for identifying dice values can also be used for placing a variety of side bets. Side bets are bonus bets placed on a round of craps that can be staked at the start of a round along with main bets/wagers, before cards are dealt and/or before dice values are identified. Various different side bets can be placed by the players, as described further below.

One or more embodiments described herein can include an electronic gaming system using common playing cards. The system includes a plurality of player computing devices that are configured to provide individualized gaming interfaces for a plurality of players; and a gaming computing device that is in communication with the plurality of player computing devices, the gaming computing device configured to: based on a plurality of sets of playing cards with one set of playing cards being dealt successive to another set of playing cards, continuously identify the plurality of sets of playing cards; based on a request to start a game from at least one of the plurality of player computing devices, identify, among the plurality of sets of playing cards being continuously identified, a first set of playing cards and a second set of playing cards; identify, among the first set of playing cards, a first card having a card value that is mapped, based on mapping data, to a first dice value, the mapping data indicating a mapping of card values to dice values; identify, among the second set of playing cards, a second card having a card value that is mapped, based on the mapping data, to a second dice value; transmit, to the at least one of the plurality of player computing devices, data representative of the first card, the second card, the first dice value, and the second dice value; determine an outcome of the game being played at the at least one of the plurality of player computing devices based on applying a gaming rule to a summation of the first dice value and the second dice value; and return the outcome of the game to the at least one of the plurality of player computing devices.

In some implementations, the embodiments described herein can optionally include one or more of the following features. For example, the electronic gaming system may include a plurality of physical playing cards that are physically dealt by a dealer; a scanner that is configured to identify each of the playing cards as they are dealt by the dealer, wherein the scanner is in communication with the gaming computing device; and a plurality of gaming tables, wherein each of the plurality of gaming tables allows the dealer to deal the physical playing cards, wherein the scanner is configured to read one or more of the physical playing cards for the gaming table. At least one of the plurality of player computing devices may be physically located at at least one of the plurality of gaming tables. At least one of the plurality of player computing devices may be physically remote from a location of at least one of the plurality of gaming tables. The gaming computing device may be configured to deal the playing cards. The request may include user selection of a graphical element presented in a graphical user interface (GUI) display at the at least one of the plurality of player computing devices. The graphical element may be a selectable option to begin a game of craps. The graphical element may be a selectable option to roll two dice in a game of craps. The graphical element may be a selectable option to place a bet on a game of craps. The gaming computing device may be configured to: associate values of the first set of playing cards with numeric values on a first dice; and associate values of the second set of playing cards with numeric values on a second dice. The first set of playing cards may represent a first dice and the second set of playing cards may represent a second dice. The second set of playing cards may be dealt immediately after the first set of playing cards. The gaming computing device may be further configured to: receive, from at least one of the plurality of player computing devices, a bet on the outcome of the game being played; determine, based on the bet and one or more gaming rules, a payout for a player at the at least one of the plurality of player computing devices; and transmit, to the at least one of the plurality of player computing devices, data representative of the payout to be presented in a GUI display at the at least one of the plurality of player computing devices. The at least one of the plurality of player computing devices may be configured to output, in a graphical user interface (GUI) display at the at least one of the plurality of player computing devices, a graphical representation of a craps table. The at least one of the plurality of player computing devices may be further configured to: receive user input indicating selection of a portion of the graphical representation of the craps table during gameplay; and transmit, to the gaming computing device, the user input as the request. Based on receiving the data representative of the first card, the second card, the first dice value, and the second dice value, the at least one of the plurality of player computing devices may be configured to output, in a GUI display at the at least one of the plurality of player computing devices, (i) a graphical representation of the first card with the first dice value overlaying a portion of the graphical representation of the first card and (ii) a graphical representation of the second card with the second dice value overlaying a portion of the graphical representation of the second card. The first dice value may be displayed in a center portion of the graphical representation of the first card and an actual value of the first card is displayed in first and second corners of the graphical representation of the first card, and the second dice value may be displayed in a center portion of the graphical representation of the second card and an actual value of the second card is displayed in first and second corners of the graphical representation of the second card. The playing cards may be physical playing cards and the gaming computing device is configured to: translate the first set of playing cards into a first set of electronic cards; and translate the second set of playing cards into a second set of electronic cards. The first card may be a first card in a card sequence in the first set of playing cards having a card value that is mapped to a dice value, and the second card may be a first card in a card sequence in the second set of playing cards having a card value that is mapped to a dice value. Each of the first and second sets of playing cards may include 5 playing cards, and the gaming computing device may be configured to discard at least one card in each of the first and second sets of playing cards, wherein the discarded at least one card does not include the first card or the second card and the discarded at least one card does not have a card value that is mapped to a dice value. Identifying, among the first set of playing cards, a first card may include identifying the first card in a card sequence of the first set of playing cards having a card value that is mapped to a dice value in the mapping data, and identifying, among the second set of playing cards, a second card comprises identifying the second card in a card sequence of the second set of playing cards having a card value that is mapped to a dice value in the mapping data. In response to determining that none of the cards in the first set of playing cards has a card value that is mapped to a dice value in the mapping data, the system may be configured to perform identifying a third set of playing cards among the plurality of sets of playing cards being continuously identified; identifying, among the third set of playing cards, a first card; determining a first dice value for the first card in the third set of playing cards based on the mapping data; and transmitting, to the at least one of the plurality of player computing devices, data representative of the first card in the third set of playing cards and the first dice value for the first card in the third set of playing cards. The gaming computing device may be further configured to: determine the outcome of the game being played at the at least one of the plurality of player computing devices based on applying a gaming rule to a summation of the first dice value for the first card in the third set of playing cards and the second dice value for the second card in the second set of playing cards; and transmit, to the at least one of the plurality of player computing devices, data representative of the outcome to be presented in a GUI display at the at least one of the plurality of player computing devices. The third set of playing cards may be dealt immediately after the second set of playing cards is dealt. The third set of playing cards may be dealt a threshold amount of time after the second set of playing cards is dealt. In response to determining that none of the cards in the first set of playing cards has a card value that is mapped to a dice value in the mapping data, the system may be configured to perform identifying, among the second set of playing cards, a first card; determining a first dice value for the first card in the second set of playing cards based on the mapping data; and transmitting, to the at least one of the plurality of player computing devices, data representative of the first card in the second set of playing cards and the first dice value for the first card in the second set of playing cards. In response to determining that none of the cards in the second set of playing cards has a card value that is mapped to a dice value in the mapping data, the system may be configured to perform identifying a third set of playing cards among the plurality of sets of playing cards being continuously identified; identifying, among the third set of playing cards, a second card; determining a second dice value for the second card in the third set of playing cards based on the mapping data; and transmitting, to the at least one of the plurality of player computing devices, data representative of the second card in the third set of playing cards and the second dice value for the second card in the third set of playing cards. In response to determining that none of the cards in the second set of playing cards has a card value that is mapped to a dice value in the mapping data, the system may be configured to perform identifying a fourth set of playing cards among the plurality of sets of playing cards being continuously identified; identifying, among the fourth set of playing cards, a second card; determining a second dice value for the second card in the fourth set of playing cards based on the mapping data; and transmitting, to the at least one of the plurality of player computing devices, data representative of the second card in the fourth set of playing cards and the second dice value for the second card in the fourth set of playing cards. The gaming computing device may be further configured to: determine the outcome of a game being played at the at least one of the plurality of player computing devices based on applying a gaming rule to a summation of the first dice value for the first card in the first set of playing cards and the second dice value for the second card in the fourth set of playing cards; and transmit, to the at least one of the plurality of player computing devices, data representative of the outcome to be presented in a GUI display at the at least one of the plurality of player computing devices. The fourth set of playing cards may be dealt immediately after the second set of playing cards is dealt. The fourth set of playing cards may be dealt a threshold amount of time after the second set of playing cards is dealt. The first set of playing cards may be different than the second set of playing cards. The first and second cards may be identified among the respective first and second sets of playing cards based on one or more card identification rules. The card identification rules may correspond to a game of craps. The gaming computing device may be further configured to: receive, from the at least one of the plurality of player computing devices, data representative of a side bet; and determine the outcome for the game being played at the at least one of the plurality of player computing devices based on applying one or more gaming rules to the side bet. The mapping data may indicate that a subset of the card values are not mapped to the dice values. The subset of the card values may include a card value of “King.” The mapping data may indicate that card values within a range of 1 through 6 are mapped to dice values within a range of 1 through 6. The mapping data may indicate that card values within a range of 7 through “Queen” are mapped to dice values within a range of 1 through 6. The request to start the game may include at least one bet to be placed on the outcome of the game. Applying a gaming rule to a summation of the first dice value and the second dice value may include determining whether the summation equals a value of 7 or a winning point value for the game; and determining that the game ended based on the summation equaling the value of 7 or the winning point value for the game. The gaming computing device may be further configured to: determine that the game continues to a next stage of gameplay based on the summation not equaling the value of 7 or the winning point value for the game; identify a third set of playing cards and a fourth set of playing cards; identify, among the third set of playing cards, a third card having a card value that is mapped, based on the mapping data, to a third dice value; identify, among the fourth set of playing cards, a fourth card having a card value that is mapped, based on the mapping data, to a fourth dice value; and transmit, to the at least one of the plurality of player computing devices and for the next stage of gameplay, data representative of the third card, the fourth card, the third dice value, and the fourth dice value. Sometimes, the gaming computing device can be further configured to provide, in graphical user interface (GUI) displays of the at least one of the plurality of player computing devices, selectable options to play multiple different games simultaneously with the plurality of sets of playing cards that are being continuously identified.

The devices, system, and techniques described herein may provide one or more of the following advantages. For example, the disclosed techniques reduce costs of labor to operate casinos and other gaming environments. Since the disclosed technology allows for continuously dealing for multiple different types of games from one set of cards (e.g., by a dealer at a gaming table and/or by a gaming computing system), less human labor is required to operate the multiple different types of games. One dealer, for example, can deal for and monitor multiple games at once from one gaming table and/or one gaming computing system. Less human labor involved can also improve efficiency and accuracy of gameplay in the multiple games and different types of games by reducing potential human error in determining gaming outcomes and gaming rules for the different types of games that may be played by players at a gaming table or remote from a physical location of the table. Less human labor involved can also reduce training or other onboarding costs for the casinos or other gaming environments that employ the disclosed technology.

Similarly, the disclosed technology also improves payout accuracy by reducing human error. In various betting games, payout schemes can be different and/or challenging to memorize and learn for a human dealer. The digital payout format of the disclosed technology avoids time, resources, and cost of training human dealers to learn all the rules of various different games and their respective payout schemes. This improves accuracy of game dealing, outcome, and payout decisions.

As another example, the disclosed technology provides increased game offerings to players. Players can play a variety of different games from their single player computing device, regardless of whether there are sufficient resources (e.g., gameplay space, chip sets, dice) to offer a full-sized game at a gaming table. The players can play the variety of games simultaneously, by toggling between graphical user interface (GUI) displays presented at their respective player computing devices during gameplay. The GUI displays can provide easy, interactive, and user-friendly experiences that encourage the players to play multiple games at once.

Table-based games can therefore be provided to a large number of players from a single table. Traditional table games have a limited number of seats available for players. In contrast, electronic gaming systems that use common cards that are being continuously dealt can allow participation of players at the physical table where the cards are being dealt as well as players who are remote from the table and/or connected to the table virtually, and allow players to participate in the game, and different types of games, at different times and play at different paces. This can expand the number of players (beyond just those seated at the physical table) for a single table to include a large number of players who may be playing a variety of different types of games remotely from a location within a gaming environment (e.g., casino, card club, race track) and/or over the internet. Additionally, the number of players can be expanded without concern for the ratio of players to remaining cards in a deck/shoe. Using the disclosed technology to reduce resources, both physical (in terms of cards, dice, table space, and dealer time to deal out each hand) and electronic (in terms of computing resources used to process game play, such as processor cycles, memory, network traffic, etc.), can make gameplay more efficient and faster. Additionally, even though the disclosed technology provides greater efficiencies, it still permits each player to individually make moves (e.g., place bets, start new games, play multiple games at once) regardless of whether they are seated at the physical table or remote, which can improve player engagement while maintaining gaming efficiencies.

The disclosed technology provides for simultaneously managing each player's gameplay in the variety of different games in real-time, such as based on timing at which they take action(s) in each game, gaming rules, game outcomes, payout determinations, betting actions, side betting actions, etc. The disclosed technology is able to manage such gameplay not only for any quantity of games played by a single player, but also any quantity of games being played by any quantity of players, including players who are physically located in a casino or gaming environment and players that are remote from such location(s) but playing the variety of different games remotely at their respective player computing devices. Consequently, more players can play games without being constrained by physical limitations of casinos, other gaming environments, and/or specific game-based limitations (e.g., a number of players who can play a particular game, a number of players who can sit at a physical gaming table).

Likewise, the disclosed technology provides for players to play at their own paces without compromising any player's gameplay. A dealer can continuously deal physical cards at a table at different time intervals. Players, both at the table and remote from the table, can perform actions on their hands, such as placing bets or starting new/additional games, at different times, and the dealer at the table does not have to wait for all the players to perform the actions to move on to a next stage of gameplay. When a player performs an action such as placing a bet in a game of craps, a request can be transmitted to the dealer's computing system for a determination of whether the player wins the bet based on the cards that are selected for being mapped to dice values. The dealer's computing system can make this determination at a same or similar time as a time of the request. Thus, a fast player may not be held up waiting for a determination of whether they win their bet because of a slower player at the table or remote from the table. Each player can play at their desired paces, regardless of the paces of other players.

Similarly, the disclosed technology provides for higher earn rate per table per day in a gaming environment. Since multiple games are offered with a same dealer at a gaming table, a frequency of players at that table playing games, whether the players are physically present or physically remote at the table, increases. Higher frequency of play increases an amount of money cycling through the table, thereby improving profits on the house.

As another example, electronic craps gaming can be provided in jurisdictions (e.g., cities, counties, states, countries) that prohibit gaming outcomes based on random number generators and pseudo-random number generators. Electronic craps gaming, like electronic craps equipment, may rely on computer-based random number generators and pseudo-random number generators to electronically determine what numbers the dice roll as. Some jurisdictions prohibit the use of random and pseudo-random number generators to determine gaming action and outcomes-meaning that in those jurisdictions, conventional electronic craps gaming is prohibited in gaming environments. By providing craps with common cards that are continuously dealt through dealer-assist electronic gaming systems and then mapped to dice values using mapping data and/or rules, electronic craps gaming can be provided to players in these jurisdictions that prohibit random and pseudo-random number generators. After all, the gaming action and outcomes are determined by physical cards that are physically dealt by a dealer rather than random or pseud-random number generators.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-B are conceptual diagrams of an example card-based electronic craps gaming system.

FIGS. 2A-B are conceptual diagrams of an example card-based electronic gaming system that can be used for the craps game of FIGS. 1A-B.

FIG. 3 is a conceptual diagram of timing for example gameplay with the card-based electronic gaming system of FIGS. 1A-B and 2A-B.

FIG. 4 depicts an example grid of continuously dealt playing cards.

FIGS. 5A-B is a flowchart of an example technique for performing card-based electronic craps gaming.

FIG. 6 is a flowchart of another example technique for determining gaming outcomes for multiple games that are simultaneously played as cards are being continuously dealt.

FIGS. 7A-C are flowcharts of example techniques for transmitting sets of cards to player computing devices.

FIG. 8 is a schematic diagram that shows an example of a computing device and a mobile computing device.

Like reference symbols in the various drawings indicate like elements.

### DETAILED DESCRIPTION OF ILLUSTRATIVE EMBODIMENTS

This document relates to electronic gaming systems and continuous progression of gameplay regardless of pacing and/or stages of gameplay of each player at a physical gaming table or remote from the gaming table. Although the disclosed technology is described in reference to craps games, the disclosed technology is also applicable to a variety of other types of games provided by electronic gaming systems, including but not limited to five-card draw poker games, baccarat, and roulette. When multiple players are involved, each player can play a game at different paces. For example, some players can leave the game and come back to it at a later time. Other players can focus only on one game and can make quick gameplay decisions that cause them to play the game relatively faster than other players. The disclosed technology provides for allowing players to play at their desired paces without being slowed down or pressured to play faster by other players. As described herein, a dealer can continuously deal sets of cards that can be ready the moment they are dealt to be transmitted to electronic gaming equipment of one or more players. For example, some players can start a game of craps at the same time and can all receive same first and second dice values, where the first dice value is mapped to a card in a first set of cards dealt within a threshold amount of time of starting the game and the second dice value is mapped to a card in a second set of cards dealt within a threshold amount of time after the first set was dealt. In another game, a first player can place a bet within a first period of time and a second player can take longer and place a bet within a second period of time. The electronic gaming system can identify a first set of cards dealt within the first period of time and a second set of cards dealt immediately after the first set, such as within the second period of time, for the first player. The electronic gaming system can identify the second set of cards dealt within the second period of time and a third set of cards dealt immediately after the second set (or within some threshold amount of time of the second set having been dealt) for the second player. Sometimes, the electronic gaming system can identify, for the second player, a set of cards that were dealt within the second period of time or within some threshold amount of time of the second period of time in addition to a set of cards dealt immediately after that set. As a result, neither cards in the identified sets may overlap for the first and second players. The first and second players can play craps at their desired paces and not have their gameplay affected by the gameplay and pacing of the other player.

Moreover, the gaming systems described herein can allow players to play side bets. The players can place side bets on top of existing wagers or bets that they placed. For example, several types of side bets can be added to a craps game. Side bets can be implemented for cards that do not map to dice values, in some implementations. Other side bets can also be placed. As an illustrative example, some side bets in craps include, but are not limited to, fire bets, different doubles, ride the line, Muggsy's corner, hard rockin' dice, fielder's choice, low dice/high dice, card craps, midway bets, bonus craps (small, tall, and all), 4 rolls no 7, golden dice challenge, 7 point 7, sharp shooter, double trip 7, point 7, replay, twice as nice, Pete and repeat, double D, broad bar 12, hot roller, repeater, under 7/over 7, and/or hard way place bets.

In addition, the gaming systems described herein can allow players to tip dealers to reimburse or otherwise reward the dealers for a positive gaming experience. For example, the players can make straight donations to the dealers using one or more options that are presented on player computing devices. The players can also tip the dealers in the form of betting for the dealer.

This document describes a variety of different features, which can be selected and incorporated into gaming systems and equipment in various combinations. For example, different jurisdictions can have different gaming regulations outlining gaming features that are permitted within the jurisdictions. Features that are compliant with the gaming regulations for a jurisdiction can be implemented (e.g., activated, included) in gaming systems and equipment deployed in that jurisdiction, and other features that are not permitted within the jurisdiction can be deactivated/not included.

The disclosed technology is described herein as applying to electronic craps games in which continuously dealt cards are identified and mapped to dice values to determine game outcomes and payouts. The disclosed technology provides for automating traditional craps gameplay with sets of continuously dealt cards, rather than rolling physical dice and placing bets on a physical craps table. Various rules can be defined and used to map card values to dice values. A craps table can be presented at computing devices of players, who may play the same or different games at their desired paces and/or from their desired locations (e.g., physically at a table where the dealer is dealing the cards or physically remote from the table or a gaming environment/facility having the table). The players can place bets through their computing devices by selecting portions of the virtual craps table as if they are placing bets on a standard, physical craps table. The players can place various types of bets, including side bets, that are known in craps gaming. The bets can be placed within a threshold amount of time. Once the threshold amount of time expires and to mimic an effect of rolling 2 dice, the gaming system can identify a first set of cards that was dealt within the threshold amount of time and a second set of cards that was dealt immediately after the first set of cards (or within a threshold amount of time after the first set was dealt). Amongst cards in the first set of cards, the gaming system can identify a first card in a card sequence that is mapped to a dice value. That card can be displayed at the player's computing devices along with the mapped dice value for a first dice in the game of craps. Amongst cards in the second set, the gaming system can identify a first card in a card sequence that is mapped to a dice value. That card can be displayed at the player's computing device along with the mapped dice value for a second dice in the game of craps. Game outcomes can be automatically determined by the gaming system and based on summating the mapped dice values that are presented to the player(s). Any bet that would pay in a traditional game of craps based on the summated dice values can be automatically paid out using the disclosed technology.

If none of the cards in the identified first and/or second sets of cards are mapped to dice values, then the gaming system can identify a next set of cards (or multiple next sets of cards) that are dealt to reconcile the bets.

The gaming system can continuously identify sets of cards that are dealt successive to each other to determine and present dice values to the player(s) until a summated dice value equals 7. Once the summated dice value equals 7, the current game of craps ends and payouts can be determined and provided to the player(s) by the gaming system.

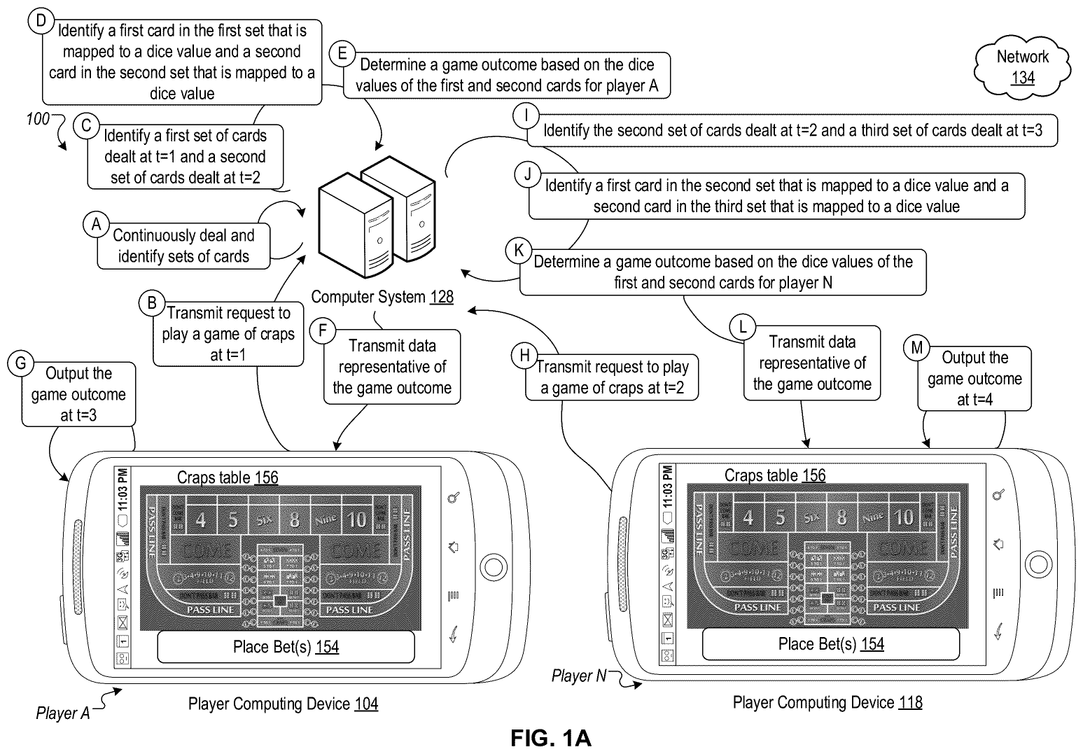

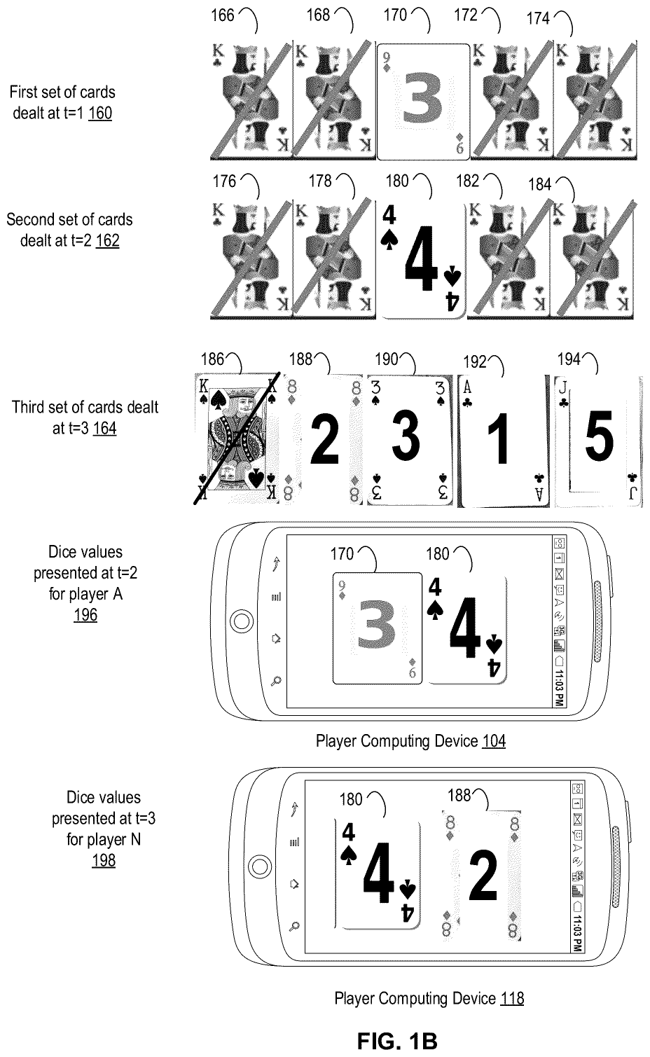

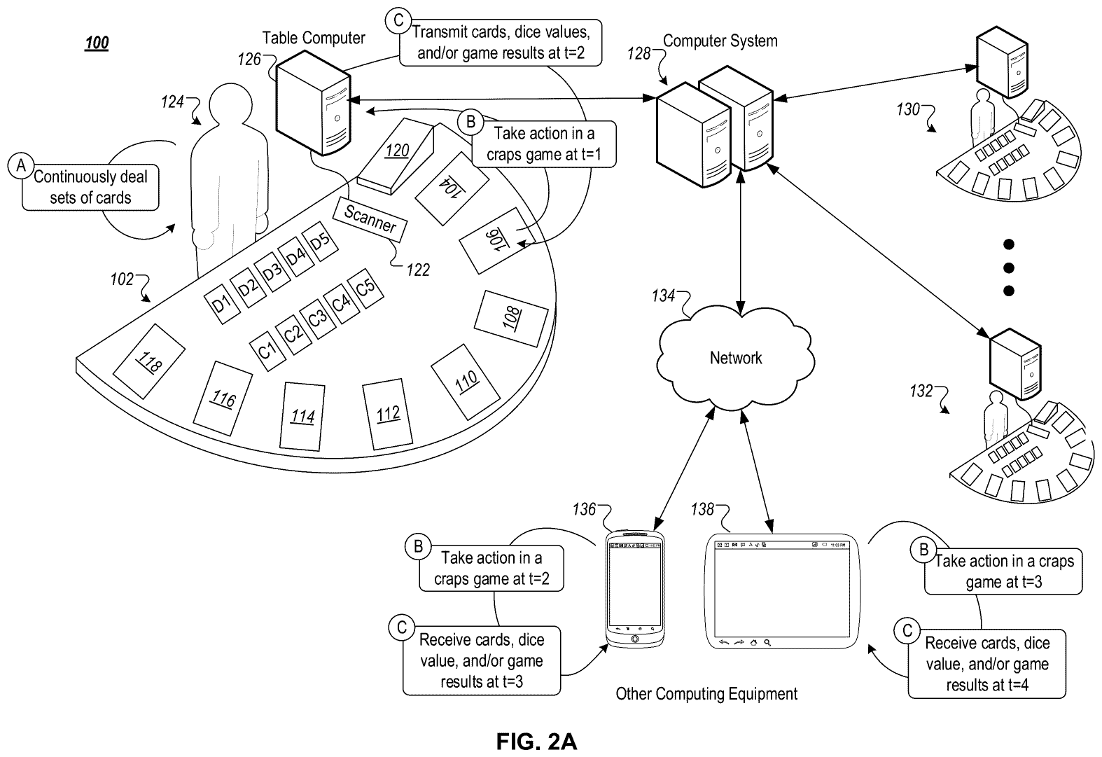

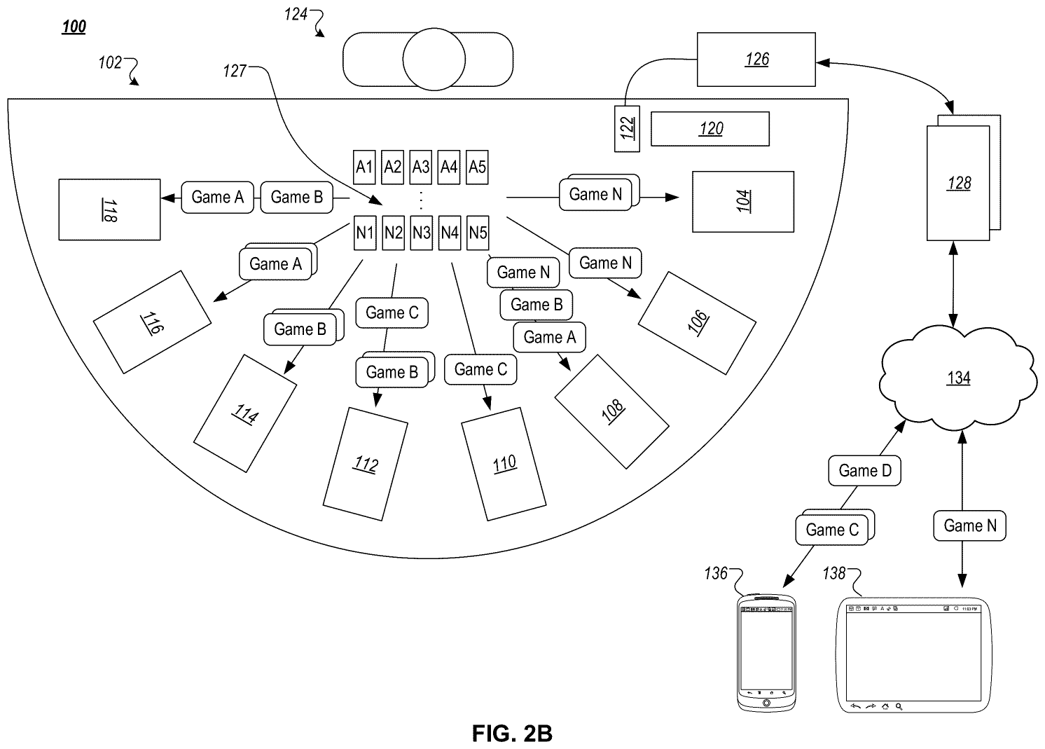

Referring to the figures, FIGS. 1A-B are conceptual diagrams of an example card-based electronic craps gaming system 100. A computer system 128 and player computing devices 104 and 118 can communicate (e.g., wired and/or wireless) via network 134. In some implementations, the computer system 128 can be a table computer, such as a table computer at a physical gaming table in a casino or other gaming environment. In some implementations, one or more of the player computing devices 104 and 118 may be part of or at the physical gaming table. At least one of the player computing devices 104 and 118 may be physically within the same casino or gaming environment as the physical gaming table and/or physically remote from the location of the casino, gaming environment, or physical gaming table. Moreover, any number of players can play a game of craps from their respective player computing devices. Refer to FIGS. 2A-C for further discussion about the components of the electronic gaming system 100.

The computer system 128 can be configured to provide card-based electronic craps gaming, as well as other gaming, to the player computing devices 104 and 118. The computer system 128 can continuously deal sets of cards (e.g., electronic cards, physical cards dealt by a dealer and scanned by a scanner), identify dealt cards are mapped to dice values, and determine game outcomes based on bets placed by players and identified cards that are mapped to dice values. As described below in reference to FIGS. 2A-B, a table computer at a physical gaming table where the physical cards may be dealt by a dealer can also be configured to perform the operations performed by the computer system 128 described in FIGS. 1A-B.

Referring to FIG. 1A, the computer system 128 can continuously deal and identify sets of cards (block A). Described further below, the cards can be physical cards that are continuously dealt by a dealer, such as a human dealer and/or a robot/machine dealer, scanned, and then translated into electronic cards having card values corresponding to the actual card values on the physical cards. Sometimes, the cards can be electronic cards and the computer system 128 can continuously deal and identify the sets of electronic cards in block A. Each set of cards can include 5 cards. Each set of cards can also include a timestamp indicating a time at which the set of cards was dealt and/or identified. The timestamp can be used to determine which set or sets of cards to use, by the computer system 128, in response to an action or request made at the player computing devices 104 and 118. The sets of cards can be used for a variety of different games offered at the player computing devices 104 and 118, including but not limited to baccarat, five-card draw poker, other poker games, roulette, and craps.

In block B, at time t=1, the player computing device 104 can transmit a request to the computer system 128 to play a game of craps. The request may include one or more bets that player A places on a craps table 156 presented in a graphical user interface (GUI) display at their player computing device 104. The player A can place the bet(s) by selecting or tapping on one or more portions of the craps table 156, similarly to how the player A would place the bet(s) on a traditional, physical craps table in which the player A would place their chips on one or more portions of the table. Additionally or alternatively, the player A can place bets by selecting a graphical element 154 presented at the player computing device 104. The graphical element 154 can be a button.

In some implementations, the player A can only place bets during a threshold period of time. The threshold period of time can be determined according to known craps gaming rules. For example, the threshold period of time can correspond to a predetermined amount of time in a traditional game of craps before or while dice are rolled (and before the dice land on dice values). Once the threshold period of time ends, the player A can no longer place bets on the current game or round of craps. The computer system 128 can then determine dice values for the player A based on cards that have been dealt at and/or within a threshold amount of time of the player A placing the bets in the threshold period of time. In electronic craps gaming, the player A can place bets during a next threshold period of time, for example at time t=2. Once the bets are placed at time t=2, the computer system 128 can determine dice values for the player A based on cards that have been dealt at and/or within a threshold amount of time of t=2.

The computer system 128 can identify a first set of cards that are dealt at time t=1 and a second set of cards that are dealt at t=2 in block C. The first set of cards can be a set of cards that was dealt (block A) at the time of the request, t=1. The first set of cards can also be identified based on having been dealt within a threshold amount of time of a last bet placed by the player A or the time of the request, t=1. To mimic an effect of rolling 2 dice in a traditional game of craps, t=2 can be immediately after t=1. Thus, the second set of cards can be identified based on having been dealt successive the first set of cards. Time t=2 can be within some threshold amount of time after t=1, in some implementations. The first and second sets of cards may also be identified using one or more other threshold amounts of time from the time of the request, t=1, as described below.

From the first set of cards, the computer system 128 identifies a first card that is mapped to a dice value (block D). From the second set of cards, the computer system 128 identifies a second card that is mapped to a dice value (block D). More particularly, for the game of craps, the computer system 128 can identify a first card in a card sequence of the first set of cards that corresponds to a dice value and a first card (e.g., the second card mentioned above) in a card sequence of the second set of cards that corresponds to a dice value. Mapping rules can be defined to map each card value in a standard 52-card deck to a dice value 1-6. Therefore, if the first card in the card sequence of the first set of cards has a card value that, according to the mapping rules/data, corresponds to a dice value of 1-6, then the computer system 128 can identify that card as the first card in block D for a first dice value. As another example, if the 5^{th} card in the card sequence of the second set of cards is the first card in the entire set to have a card value that is associated with a dice value, then the computer system 128 can identify the fifth card in block D as a second dice value. As yet another example, if none of the cards in a set of cards has a card value that is mapped to a dice value, then the computer system 128 can identify a subsequent set of cards that were dealt and perform block D on the subsequent set of cards. The subsequent set of cards can be a set of cards that was dealt immediately after the first and/or second set of cards. The subsequent set of cards can also be a set of cards that was dealt a threshold amount of time after the first and/or second set of cards.

The computer system 128 can determine a game outcome based on the dice values of the first and second cards for the player A (block E). For example, the computer system 128 can summate the dice values for the first and second cards to determine a total dice value. If the total dice value equals 7, then the computer system 128 can determine that the game ends. The computer system 128 can automatically determine game outcomes and/or payouts based on the bet(s) placed by the player A. If the total dice value equals a “point” or win value for the current game (which, as an example, can be determined at the start of a game as the total dice value determined in block E), then the computer system 128 determines that the game ends. As another example, if the total dice value does not equal 7 or the point/win value, then the computer system 128 can determine that the current game continues and new dice values can be identified from 2 new sets of cards that are being continuously dealt (which corresponds to 2 dice being rolled again in a traditional game of craps). Dice values and game outcomes can continuously be identified/determined until either a total dice value equals 7 or the total dice value equals the point or win value for the current game. The 2 new sets of cards can be identified based on being dealt within a threshold amount of time of determining the game outcome in block E. The 2 new sets of cards can also be identified based on being dealt at a same time as determining the game outcome. In some implementations, the 2 new sets of cards may be identified based on being dealt within a threshold amount of time of the player A placing additional or new bets after receiving the game outcome from the computer system 128. The 2 new sets of cards can be identified according to one or more other rules.

In block F, the computer system 128 can transmit, to the player computing device 104, data representative of the game outcome. Sometimes, the computer system 128 can transmit data representative of the first and second cards with their corresponding mapped dice values at a first time and then transmit data representative of the game outcome at a second time. The first time can occur before the second time. The first time can, for example, occur before the computer system 128 determines the game outcome in block E. The second time can then occur after the computer system 128 determines the game outcome in block E. The data transmitted to the player computing device 104 can include graphical representations of the first and second cards along with their respective mapped dice values. The data can also include a total dice value for the first and second cards. The data can include information indicating whether a 7 was rolled and/or whether the point/win value was rolled. The data can additionally or alternatively include information indicating whether the current game of craps has ended, whether the game continues until a 7 or the point/win value is rolled, a payout for the player A, and/or one or more options for the player A to place additional or new bets or side bets.

The player computing device 104 can output the game outcome and/or any other information transmitted in the data in a GUI display (block G). This information can be outputted at the player computing device 104 at time t=3, or any other time after t=1. Refer to FIG. 1B for further discussion about the information that can be outputted at the player computing device 104.

Although not depicted in FIG. 1A, the player computing device 104 can also output results that include whether the player A won their bet(s), a payout, and/or betting options to play another game or continue playing in a current game.

Similar to the blocks B-G, blocks H-M can be performed for player N with regards to the player computing device 118, or any other player computing device or computing equipment described herein. For example, the player N at the player computing device 118 can transmit a request to play a game of craps at time t=2 (block H). The request can include one or more bets placed by player N within some threshold amount of time. As an illustrative example, player A and player N can start the game of craps at the same time t=0. The player A can be a faster player, and may provide their bets at t=1, within a designated threshold amount of time. As a result, the computer system 128 can use cards that were dealt at t=1 and immediately after t=1 (or within some threshold amount of time of t=1) to determine dice values and game outcome for the player A. Since the player N is a slower player, the player N may not provide their bets until t=2, which is after the designated threshold amount of time for placing bets. As a result, the computer system 128 can use cards that were dealt at t=2 and immediately after t=2 to determine dice values and game outcome for the player N. Time t=2 can be any time after time t=1. As a result, and as described above, different sets of cards may be used to determine dice values and game outcome for the players A and N due to their different pacing of gameplay. Sometimes, as shown in FIG. 1A, a same set of cards may be used to determine the dice values and game outcomes for both the players A and N.

Once the computer system 128 receives the request in block H, the computer system 128 can identify a second set of cards dealt at or around/within a threshold amount of time of the time t=2 and a third set of cards dealt at or around/within a threshold amount of time of time t=3 (block I). The second set of cards identified in block I can be the same as the second set of cards identified in block C. Sometimes, the second set of cards identified in block I can be different than the second set of cards identified in block C. As an illustrative example, for gameplay of the player N, the computer system can identify a set of cards dealt at time t=3 and a set of cards dealt at time t=4 so as to not use a same set of cards that were dealt for gameplay of both the player A and the player N.

The computer system 128 can then identify a first card in the second set of cards that is mapped to a dice value and a second card in the third set of cards that is mapped to a dice value (block J), as described in reference to block D. The computer system 128 determines a game outcome based on the dice values of the first and second cards for the player N (block K). Refer to block E for further discussion. Then, the computer system 128 transmits data representative of at least the game outcome to the player computing device 118 (block L), and the player computing device 118 outputs at least the game outcome at t=4 (block M). Refer to blocks F-G for further discussion.

Referring to FIG. 1B, a first set of cards 160 dealt at time t=1, as described in reference to blocks A and C in FIG. 1A, can include cards 166, 168, 170, 172, and 174. In this illustrative example, cards 166, 168, 172, and 174 are all King of Clubs and card 170 is a red 9 of Diamonds. The computer system 128 can use one or more predetermined rules and/or mapping data to identify which, if any of the cards 166-174 in the first set of cards 160 is mapped to dice values and therefore can be used for a first dice value during a current game. In this example game, all King cards can be considered non-value cards. Therefore, the computer system 128 can discard the cards 166, 168, 172, and 174. The remaining card 170 can be mapped to a dice value. For example, card values of 7-Queen can be mapped to dice values 1-6. The card 170 has a card value of 9, which, according to the above example mapping, is mapped to a dice value of 3, as shown in the first set of cards 160 dealt at t=1.

At time t=2, a second set of cards 162 is dealt. The second set includes cards 176, 178, 180, 182, and 184. In this example, the cards 176, 178, 182, and 184 are all King of Clubs and card 180 is a black 4 of Spades. The computer system 128 discards the cards 176, 178, 182, and 184 since they are defined as non-value cards in the applied rules and/or mapping data. The card 180 remains as a second dice value since the card 180 has a card value of 4, which is mapped to a dice value of 4.

At time t=3, a third set of cards 164 are dealt. The third set includes cards 186, 188, 190, 192, and 194. In this example, the card 186 is a black King of Spades, the card 188 is a red 8 of Diamonds, the card 190 is a black 3 of Spades, the card 192 is a black Ace of Clubs, and the card 194 is a black Jack of Spades. The computer system 128 discards the card 186 for being a non-value card. The card 188 has a card value of 8, which is mapped to a dice value of 2. The card 190 has a card value of 3 and is mapped to a dice value of 3. The card 192 has a card value of Ace and is mapped to a dice value of 1. Finally, the card 194 has a card value of Jack and is mapped to a dice value of 5. In such a scenario, the computer system 128 can identify the first card in the card sequence of the third set of cards 164 that is mapped to a dice value. The identified first card can then be selected for a third dice value. Here, since the card 186 in the card sequence is discarded, the next card in the card sequence that is mapped to a dice value is the card 188. Therefore, the card 188, which is mapped to a dice value of 2, is selected by the computer system 128 as the third dice value.

Still referring to FIG. 1B, the player A can be playing a game of craps (e.g., place bets) at a first time t=1 and the player N can be playing a game of craps (e.g., place bets) at a second time t=2. Since the player A plays at the first time t=1, the player A can receive the dice values that are mapped to the card 170 in the first set of cards 160 dealt at t=1 and the card 180 in the second set of cards 162 that was dealt immediately after the first set of cards 160, at t=2. The cards 170 and 180 can be presented in a GUI display of the player A's computing device 104 at time t=2. As shown in FIG. 1B, the mapped dice values can also be displayed over center portions of the respective cards 170 and 180. In some implementations, the player computing device 104 can also output a total dice value. In the case of the player A, the total dice value would be 7. A game of craps ends when the total dice value is 7, so the computer system 128 can determine a game outcome and payout for the player A based on the player A's bets and the total dice value being 7. The player A can decide to play another game at time t=2. If they place their bets at t=2, the player N may receive the same cards as the player N, who also placed their bets at t=2. If the player A places their bets at time t=3, for example, they can receive the dice value mapped to the card 188 from the set of cards 164 dealt at t=3 and a dice value mapped to a card from a set of cards dealt immediately after, such as at time t=4.

The player N receives the dice values that are mapped to the card 180 in the second set of cards 162 that was dealt at t=2 (when the player N placed their bets) and the card 188 in the third set of cards 164 that was dealt immediately after the second set of cards 162. The cards 180 and 188 are presented in a GUI display of the player computing device 118 at time t=3. The mapped dice values are also be displayed over center portions of the respective cards 180 and 188. The player computing device 118 can also output a total dice value. In the case of the player N, the total dice value would be 6. Since the total dice value is not equal to 7, the computer system 128 can continue to identify successive sets of playing cards having cards mapped to dice values and determine game outcomes, as described herein. Moreover, the player N can continue placing bets in between each set of dice values being presented to the player N at their computing device 118. If the total dice value equals a point/number for the game, then the game ends and payouts are determined. The computer system 128 can continue to identify the successive sets of playing cards with cards mapped to dice values until either a 7 is rolled or the point/number for the game is rolled.

FIGS. 2A-B are conceptual diagrams of an example card-based electronic gaming system 100 that can be used for the craps game of FIGS. 1A-B. As shown in FIG. 2A, the system 100 includes an example gaming table 102 that includes player computer devices 104-118 (e.g., touchscreens, electronic screens or displays) that are located at each of the positions for the table 102. The table 102 also includes a scanner 122 that is configured to automatically detect cards that are dealt out of the shoe 120 by a dealer 124. In some implementations, the scanner 122 can also be configured to automatically detect cards that are dealt out of the shoe 120 by a robot dealer, a table computer 126, or another computing system, such as the computer system 128, described above in reference to FIGS. 1A-B.

The scanner 122 can be implemented in any of a variety of ways, such as an optical scanner that is configured to detect each card that is dealt from the shoe 120 through optical recognition of one or more unique portions of the cards (e.g., image recognition techniques to identify the suit and number for each card and/or to identify a code printed on each card, such as a barcode or QR code), radio frequency-based identification (e.g., recognition of RFID tags included in each card), and/or other identification techniques. The scanner 122 can be a barcode scanner, QR code scanner, camera (e.g., overhead camera(s) over the table 102), other optical scanner, RFID reader, or other radio frequency scanner that can accurately detect physical playing cards that are dealt by the dealer 124 (e.g., a human or a robot at a physical gaming table) and to use those dealt cards to provide electronic gaming outcomes to players. Gaming systems that use any of a variety of card scanners to obtain physical card information may be referred to as “dealer assist” gaming systems. In some implementations, the cards that are dealt out of the shoe 120 are specialized playing cards with one or more features (e.g., codes, RFID tags) that are specifically designed for detection by the scanner 122. In other implementations, the cards that are dealt out of the shoe 120 are standard playing cards without specially designed features.

Card-based electronic roulette gaming is provided at the table 102 through the use of table computer system 126 that, in combination with the scanner 122, detects the cards that are dealt from the shoe 120 by the dealer 124 (which can be a human, robot, or other mechanical dealing equipment/machine), manages gaming information and interactions through the player computer devices 104-118, and determines gaming outcomes based on the cards that are dealt and the player actions (as designated through the devices 104-118). As described herein, the computer system 128 can also perform any one or more of the abovementioned functions, processes, and techniques. The shoe 120 can store one or more decks of physical playing cards that are ordered within the shoe 120 through physical shuffling of the cards (e.g., machine shuffling, manual shuffling, or a combination thereof). Through these collective parts (table 102, table computer system 126, scanner 122, shoe 120, dealer 124, devices 104-118), the system 100 can provide dealer assist electronic gaming to players through the use of physical cards, including games such as craps, which traditionally are played with dice instead of playing cards. The system 100 can also simultaneously provide a variety of different dealer assist electronic games, including but not limited to, electronic five-card draw poker, baccarat, and roulette.

Sometimes, the table computer system 126 is programmed to use common cards to provide craps gaming across the players through the devices 104-118. Sometimes, only some of the devices 104-118 can be occupied by players. Further, the players can join the game at different times before or while the cards are being dealt by the dealer 124 at the table 102, as described further in reference to FIG. 1A. Players at each of the occupied player computing devices can select selectable options presented at their devices to perform player actions. For example, the players can select graphical elements representing buttons to place one or more bets in a game of craps. The players can also select portions of a graphical representation of a craps table to play their bets. In another example, the devices 104-118 can include physical buttons corresponding to different type of gaming actions that can be taken in a game of craps. Player actions can be maintained locally on the devices 104-118 and/or can be transmitted to the table computer system 126.

The dealer 124 can continuously deal sets of cards, one example of which is a set of cards D1-D5 (block A). The dealer 124 can deal cards at a particular interval, for example, every 5 seconds, 10 seconds, 15 seconds, 20 seconds, 30 seconds, etc. Since the dealer 124 is continuously dealing cards, whenever one of the players requests to play a game of craps, they can immediately receive dice values that are mapped to cards dealt at a same time or similar time as a time of the request/a bet (e.g., a time shortly after the time of the request). The players can continue to play the game at their desired paces, without being slowed down by gameplay pacing of other players. 5 cards, such as the cards C1-C5, can be exposed, and the cards can continuously be shuffled into decks. Multiple players can then play off the same 5 cards or sets of 5 cards at their desired paces. As a result, an entire process of the game may not be slowed down. Fast players may not have to wait for slower players to take gaming actions. Furthermore, the odds can become different since all the cards except for the 5 exposed cards are continuously being shuffled and transmitted to players based on times at which they request sets of cards (e.g., start a game, place bets). Continuous shuffling and dealing can therefore mitigate risk that multiple players may win with the same cards.

Since the dealer 124 is continuously shuffling and dealing sets of cards, players can join a game at any moment. The new player can receive dice values corresponding to cards that were dealt in a first set at a time at which the player joins the game and in a second set at a time immediately after the first set of cards were dealt. In the example of FIG. 2A, the new player can receive a first dice value corresponding to one card in the set of cards D1-D5 and a second dice value corresponding to a card in the set of cards C1-C5. The set of cards C1-C5 can be dealt immediately after the set of cards D1-D5. Another player might have started the game earlier but did not place bets until the new player joined the game. As a result, the another player and the new player can receive the same dice values from the same sets of cards.

The table computer system 126 and/or the player devices 104-118 can determine the outcome of the game for each player based on the dice values derived from the dealt cards, such as the first set of cards D1-D5 and the second set of cards C1-C5, the player's actions (e.g., bets, side bets), and one or more craps gaming rules.

In some implementations, only one set of currently dealt cards (e.g., C1-C5) can be presented on the table 102 and a previously dealt set of cards (e.g., D1-D5) can be discarded or otherwise moved aside from the table 102. In some implementations, the table computer system 126 (in combination with the central computer system 128 described above) can determine and manage gaming at each of the positions, and can simply use the devices 104-118 to present information to the players and to obtain player inputs (e.g., bet amounts). In other implementations, each of the devices 104-118 can manage an individual player's gaming and can communicate with the table computer system 126 to receive card information. Other implementations are also possible.

The system 100 can additionally incorporate and permit remote players to play roulette on the table 102, such as through other computing equipment 136 and 138 (e.g., smartphones, tablet computers, wearable computing equipment (e.g., smart watches), desktop computers, laptop computers, media computers, virtual reality systems, augmented reality systems). For example, the system 100 can use the central computer system 128 to connect remote players with the table computer system 126 so that remote players can additionally participate in craps gaming on the table 102. Such remote players may be located in the same facility as the table 102 (e.g., casino, card club, horse track) and/or remote from such a facility (e.g., located remotely, at home). Via the equipment 136 and 138, the remote players can connect to the computer system 128 and the table computer system 126 to participate in craps gaming at the table 102 and/or other tables 130-132 over one or more networks 134, such as the internet, local area networks (LAN), wide area networks (WAN), virtual private networks (VPN), mobile data networks (e.g., 4G LTE networks), wireless networks (e.g., Wi-Fi networks, BLUETOOTH networks), and/or combinations thereof. The remote electronic equipment 136 and 138 can download and run code from the computer system 128 to provide electronic craps gaming on the equipment 136 and 138, as described in reference to the computing devices 104-118. Such code can be, for example, a mobile application (“mobile app”) that is downloaded and installed on the computing equipment 136 and 138, a browser-based application that is downloaded and run within a web browser application on the computing equipment 136 and 138, a standalone application that is downloaded and installed on the computing equipment 136 and 138, and/or other types of code and/or applications.

The computer system 128 can additionally allow players, such as local players using devices 104-118 and/or remote players using equipment 136-138, to bounce between gaming at tables 102 and 130-132, to play multiple games or hands simultaneously/concurrently across the tables 102 and/or 130-132, and to even combine common cards from multiple different tables 102 and 130-132 for various bets and/or side bets. For example, a player can press a button requesting that the computer system 128 place him/her in the table that is going to be dealing next, so as to allow the player to minimize wait time. The computer system 128 can automatically transfer such a player to a table that is the first to scan sets of cards for dice values, and can present the dice values from that table to the player, even though the player may be located at another table or remote from the table. In a further example, a player may be permitted to concurrently play multiple hands or games across the tables 102 and/or 130-132. Additionally, the computer system 128 may perform load balancing of players so as to more evenly distribute players across the tables 102 and 130-132.

The computer system 128 can additionally distribute video, audio, and/or chat feeds for the tables 102 and 130-132 to remote players using the computing equipment 136-138.

Still referring to FIG. 2A, the dealer 124 can continuously deal sets of cards in block A. For example, as soon as at least one player joins a game, the dealer 124 can start to deal sets of cards and continue to deal sets of cards until all the players are done, the game has ended, or some input is received that indicates an end of gameplay. The dealer 124 can deal cards at a dealer-desired pace (e.g., as quickly as the dealer 124 can shuffle and deal sets of cards and/or at timed intervals, as described above). The dealt cards can be scanned by the scanner 122. Once scanned, the dealt cards are ready to be transmitted to any of the devices 104-118 and/or the other player computing equipment 136-138 when requested by the players. In some implementations, the dealer 124 may wait to deal sets of cards until a first player has joined a game. In some implementations, the dealer 124 may wait to deal sets of cards until one player provides first input at their devices 104-118 and/or computing equipment 136-138. The first input can, for example, be a pause action, a resume action, and/or at least one bet. In yet some implementations, the dealer 124 can continuously deal sets of cards regardless of whether and/or when a player joins a game at the dealer 124's table 102.

Players can take action in a craps game at time t=1 in block B. For example, the players can place bets on a craps table presented at their respective devices 104-118. The bets can be placed within a threshold amount of time. Once the threshold amount of time ends, the players can no longer place bets for during the current round or stage of gameplay. In other words, the player can place a bet during a subsequent threshold amount of time, during which new dice values will be determined from a new sets of cards that are being dealt. As described herein, players can provide input at their devices 104-118 and/or computing equipment 136-138 indicating that they are placing one or more bets, which can be transmitted from the player's computing equipment to the table computer 126 or the computer system 128. Based on this input, the table computer 126 or the computer system 128 can determine a gaming outcome and/or a payout for the particular player.

In block C, the table computer 126 can transmit, to the devices 104-118 and/or 136-138, cards, their corresponding dice values, and/or game results at time t=2. Refer to FIGS. 1A-B for further discussion about identifying the cards and their corresponding dice values, determining game outcomes, and determining game results.

The table computer 126 can maintain each set of dealt cards with a respective timestamp indicating a time at which the set of cards was dealt and/or scanned by the scanner 122. When an indication of game action (e.g., when a player starts a new game or places a bet) or other input is received from one or more player computing devices 104-118, the table computer 126 can identify a first set of dealt cards having a timestamp that is most similar to (e.g., shortly after or shortly before) a timestamp of the indication of game action and a second set of dealt cards having a timestamp immediately after or within a threshold amount of time of the first set of dealt cards. Using the identified sets, the table computer 126 can identify first and second cards that are mapped to dice values and transmit the identified cards and their corresponding dice values to each of the players' computing equipment (e.g., the devices 104-118 and/or the computing equipment 136-138). Sometimes, the identified sets of dealt cards can be transmitted to each of the players' computing equipment and the players' computing equipment can identify which cards are mapped to dice values and therefore should be presented to the players.

In some implementations, the table computer 126 can associate times at which physical cards are dealt with times at which such cards are scanned by the scanner 122 and registered by the table computer 126. This can be advantageous to recognize lag and/or relative timing to more accurately determine which sets of cards should be transmitted to which player computing equipment. As a result, players who are physically at the table 102 may not have advantages over online or remote players who cannot see the cards being physically dealt at the table 102. Moreover, online or remote players may not be able to take advantage of the time lag described above to know in advance what next cards will be registered and then transmitted to them.

FIG. 2B is another conceptual diagram of the example card-based electronic gaming system 100. Here, the table computer 126 may use prerecorded sequences of cards that are dealt into grid 127, which may be a virtual grid of cards. The shoe 120 can store one or more decks of physical playing cards that are randomly ordered within the shoe 120 through physical shuffling of the cards (e.g., machine shuffling, manual shuffling, or a combination thereof).

The size and shape (e.g., the number of columns and rows) for grid 127 may vary based on the type of game(s) being offered by system 100 and/or the number of players that can be supported by system 100. The dealer 124 may place each card as dealt from the shoe 120 into the grid 127 based on a particular pattern. For example, a first card may be placed in position A1, a second card may be placed in position A2, and so forth until the grid is filled. As an alternative example, the first card may be placed in position N5, the second card may be placed in position N4, and so forth until the grid is filled. Any number of patterns may be employed to fill the grid 127. The pattern can be switched by the dealer 124 after each grid is used to determine gaming outcomes or after a particular number of grids have been dealt and used. The patterns used for card placement into the grid 127 may be rotated through based on a particular ordering of the patterns. Grid 127 may also be built virtually by the table computer 126 as the cards are dealt by the dealer 124 and read by the scanner 122, or based on a prerecorded dealt sequence of cards.

Through these collective parts (table 102, computing device 126, scanner 122, shoe 120, dealer 124, devices 104-118), the system 100 can provide dealer assist electronic gaming to players through the use of physical cards as dealt into the grid 127, where the gaming outcomes are determined by the random ordering of physical playing cards within the shoe 120 instead of through a random or pseudo-random number generator.

The table computer 126 determines initial and next gaming outcomes for each player computer device 104-118 and remote computer devices/equipment 136-138 based on the cards in grid 127 for both card based and non-card based games. Examples of card based table games include, but are not limited to, Baccarat, Blackjack, Casino war, Faro, Poker and its variants, Red Dog, Teen Patti, and Trente et Quarante. Examples of non-card based table games include, but are not limited to, Roulette, Chuck-a-luck, Craps, Pai Gow, Sic bo, Big Six wheel, Roulette, Fan-Tan, and Two-up. The table computer 126 may employ multiple grids to manage multiple games at the same time or to use one grid from which to select initial hands and another grid from which to select additional or replacement cards.

Similarly to the example in FIG. 2A, the table computer 126 is programmed to use common cards that are continuously dealt to provide electronic gaming to the players through the devices 104-118. For example, the table computer 126 can detect a card that is mapped to a dice value based on the cards dealt by the dealer 124 and their placement in grid 127. The table computer 126 can transmit information identifying the identified card to the player devices being currently occupied by players (e.g., one, some, or all of the devices 104-118). Each of the occupied player devices, which can be any of a variety of computing devices with an associated display (e.g., tablet computing device, embedded computing device) as described herein, can present the identified card and corresponding dice value to the players along with selectable options to place bets, wages, or other gaming actions. For example, the devices 104-118 can include touchscreens that present selectable buttons to place a bet before the identified card (as well as a second identified card corresponding to a second dice) is presented to the players. In another example, the devices 104-118 can include physical buttons corresponding to different actions that the players can take in a game of craps. Additionally, multiple games/hands may be displayed by the devices 104-118 to a respective player. Player actions can be maintained locally on the devices 104-118 and/or can be transmitted to the table computer 126.

The dealer 124 may also deal a second grid 127 of cards from which one or more cards that are mapped to dice values can be selected by the table computer 126. The second grid 127 may be dealt according to the same pattern as the first grid or a different pattern may be used. The table computer 126 may use any variety of rules to identify which card having a mapped dice value in the card sequence A1-A5 should be assigned and presented to the players at the occupied player devices. As an illustrative example, a first dice value can be determined from a card in the first grid and a second dice value can be determined from a card in the second grid. Other options are also possible to identify the first and second dice values in a game of craps.

The table computer 126 and/or the player devices 104-118 can determine the outcome of the game for each player based on the cards provided from the grid 127, which have corresponding dice values, the player's actions (e.g., bets), and craps gaming rules. In some implementations, the table computer 126 (in combination with a central computer system 128) can determine and manage gaming at each of the positions, and can use the devices 104-118 to present information to the players and to obtain player inputs (e.g., bet amounts, side bets). In the depicted example of FIG. 2B, the table computer 126 manages Games A-N for each of the devices 104-118 as well as remote devices 136-138. In other implementations, each of the devices 104-118 can manage an individual player's gaming and can communicate with the table computer 126 to receive card information. Other implementations are also possible.

As described above in reference to FIG. 2A, each of the players at the devices 104-118 can receive sets of cards, cards, or other gaming information for each of the Games A-N based on times at which the players provide input for each game. The dealer 124 can continuously deal sets of cards that are scanned by the scanner 122. The table computer 126 can then receive requests for cards (e.g., requests to start new games) from any of the devices 104-118 and/or the computing equipment 136-138. The table computer 126 can transmit cards that were dealt at times that are the same or similar to the requests for any of the Games A-N that are played at the devices 104-118 and/or the computing equipment 136-138. Thus, continuous gameplay progression can exist for each of the players in each of their Games A-N. The players can continue to play a variety of different games at their desired paces without having to slow down or speed up gameplay to compensate for gameplay paces of other players at the table 102 and/or remote from the table 102.

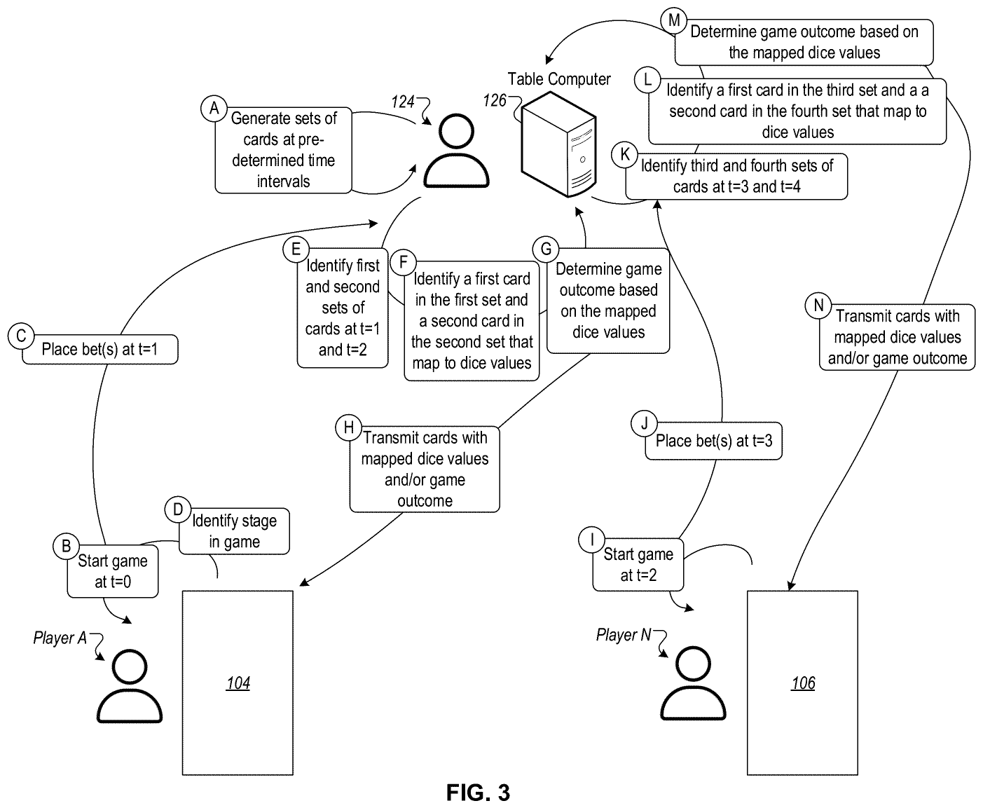

FIG. 3 is a conceptual diagram of timing for example gameplay with the card-based electronic gaming system of FIGS. 1A-B and 2A-B. Here, 2 players A and N are playing a game at player computer devices 104 and 106, respectively. The dealer 124 continuously generates sets of cards at predetermined time intervals in block A. As described with regards to FIGS. 2A-B, the dealer 124 can continuously deal sets of cards that are scanned by the scanner 122 and transmitted to the table computer 126. The players A and N may play one or more games at different paces. A first group of players, for example, who play at a same pace can receive the same dice values that correspond to cards dealt by the dealer 124 at a first time and a second time immediately after the first time (or a threshold amount of time after the first time). A second group of players can play games at another pace and therefore receive different dice values that corresponds to cards that were dealt by the dealer 124 at the second time and a third time immediately after the second time (assuming that the players place their bets/take action at the second time). Although each of the groups may receive different dice values from the same dealer 124, one or more of the second group of players may still play the same games as one or more of the players in the first group, albeit at different paces.

Sometimes, first and second players can start a game of craps together but then continue the game at different paces. For example, a second player can be slower in gameplay than a first player (e.g., the second player can step away from their computing device for some period of time, they may be switching between playing different games). The second player can then receive dice values from at least one different set of dealt cards than the first player, who started the game at the same time but plays the game quicker. The first player may receive at least one dice value that corresponds to a card that was dealt in a set of cards before another card in another set of dealt cards that was used to assign at least one dice value for the second player's gameplay.

With regards to player A in FIG. 3, player A can start the game, such as a game of craps, at time t=0 in block B. The player A can start the game before or during a time at which the dealer 124 is dealing the sets of cards. Starting the game can include the player A performing some action or providing some user input at the device 104 that indicates the player A is ready to play the game. For example, the player A can select an option at the device 104 to begin a new game, to resume a game, to select a game to play, or to take some action (e.g., place one or more bets) in a game.

Player A can place at least one bet at time t=1 in block C. This user input can be transmitted to the table computer 126. The request can include a timestamp indicating a time at which the player A places the bet(s). Sometimes, the timestamp can indicate the time at which the player A begins the game (e.g., t=0) instead of the time at which the request is transmitted to the table computer 126 (e.g., t=1). Sometimes, time t=1 can be the same time as time t=0. For example, when the player A selects an option to begin a new game at the device 104, the player A can place their bet(s) and/or the device 104 can immediately/automatically transmit the request to the table computer 126. Sometimes, time t=1 can be the same, earlier, or later than a time at which the dealer 124 begins dealing cards or otherwise is currently dealing sets of cards in block A. Thus, the dealer 124 can already be dealing sets of cards at time t=1. In other implementations, the dealer 124 may not begin to deal sets of cards until time t=1, when the bet(s) is first received from the device 104 of the player A.

The device 104 can sometimes identify what stage the player A is currently at in the game in block D. The device 104 can make this identification before, during, or after transmitting the bet(s) to the table computer 126 in block C. Moreover, sometimes, the device 104 can make this identification instead of the table computer 126 in order to more efficiently utilize computing resources and to avoid clogging resources of the table computer 126. An indication of the stage of gameplay can also be transmitted, by the device 104, to the table computer 126. The table computer 126 can use the stage of gameplay to identify whether to identify dice values for the player A's current gameplay, whether to determine a game outcome, and/or whether to determine payout for the player A.

For example, in block D, the device 104 can determine whether the player A is at an initial stage in which the player A has just started the game and is not yet ready to place bets. The device 104 can also determine whether the player A is at betting stage in the game in which the player A can place one or more bets during a threshold period of time. The device 104 may determine whether the player A is at a current stage of gameplay in which a number 7 or a point for the game has not yet been rolled, so new dice values need to be generated for the player A to continue the craps gameplay. The device 104 can also determine whether the player A is at a final stage of the game, in which gaming outcomes, payouts, and/or options to start a new game are to be determined by the table computer 126 and presented to the player A at their respective computing device 104.

In block E, the table computer 126 can identify first and second sets of cards that were generated (e.g., dealt by the dealer 124 and/or scanned by the scanner 122) at a time of the bet(s) (e.g., t=1) and a time immediately after time t=1 (or within some threshold amount of time of t=1), such as time t=2. Sometimes, the table computer 126 can identify the first set of cards that were generated within some predetermined time range from the time of placing the bet(s), t=1, and/or the time of starting the game, t=0. If, for example, a set of cards was generated at the same time as t=1, then the table computer 126 can identify that set of cards in block E as the first set. As another example, if the first set of cards was generated at a time that is several seconds before time t=1 and a second set of cards was generated at a time that is several seconds after time t=1, the table computer 126 can identify both the first and second sets of cards. Refer to FIGS. 1A-B for further discussion about identifying the first and second sets of cards.

In block F, the table computer 126 can identify a first card in the first set of cards and a second card in the second set of cards that each map to dice values. In other words, the table computer 126 can identify a first card in a card sequence of the identified first set of cards that is mapped, according to mapping data and/or mapping rules, to a dice value. The table computer 126 can also identify a first card in a card sequence of the identified second set of cards that is mapped, according to the mapping data and/or mapping rules, to a dice value. Any cards in the first and second sets that are not mapped to dice values, according to the mapping data and/or mapping rules, can be discarded. Discarding those cards means they may not be dealt in subsequent sets. In some implementations, the discarded cards may be dealt in subsequent sets. Refer to FIGS. 1A-B for further discussion about identifying cards that are mapped to dice values.

The table computer 126 can also determine a game outcome based at least in part on the mapped dice values in block G. For example, the table computer 126 can add/summate the dice values of bloc F to determine a total dice value for the current game of craps. The table computer 126 can apply one or more craps gaming rules to determine whether the total dice value equals 7 (and therefore the game naturally ends), whether the total dice value equals a point for the current game of craps (and therefore the game ends), and/or whether the total dice value equals a value other than 7 or the point for the game (and therefore gameplay continues and new dice values are determined). The table computer 126 can determine one or more other game outcomes and/or payouts based on applying known craps gaming rules to the total dice value and the bet(s) placed by the player A.

The table computer 126 can transmit the cards with their mapped dice values and/or the game outcome to the device 104 in block H. Sometimes, the cards with the mapped dice values can be transmitted at a first time and the game outcome can be transmitted at a second time. The first and second times can be the same. The first and second times can also be different. For example, the first time can be before the second time. For example, the cards with their mapped dice values can be transmitted to the device 104 after the cards have been identified in block F. The game outcome can then be transmitted after the game outcome is determined in block G. A threshold amount of time may also pass between the first and second times. Other variations in timing of transmitting data to the device 104 are also possible.

Sometimes, whenever sets of cards are generated in block A, the table computer 126 can transmit those sets of cards to the device 104. The device 104, instead of the table computer 126, can perform one or more of blocks E-G. This can be advantageous to reduce an amount of processing at the table computer 126. By offloading such processing to the device 104 and other player computer devices, the table computer 126 can more efficiently use its computational resources to make other determinations (e.g., determining gaming outcomes).

Still referring to FIG. 3, the blocks described in reference to the game of player A can also be performed in reference to the game of player N. Here, player N starts the game at t=2 (block I). Sometimes, at t=2, the player A can be done with a first game of craps and starting a new game of craps. Sometimes, the player A may still be placing bets at time t=2 or gameplay may otherwise be continuing (e.g., because a 7 was not rolled or the point of the player A's game was not rolled). In such a scenario, the players A and N may receive at least one of the same dice values, where the at least one same dice value can correspond to a card that was dealt at or around t=2.

One or more bets can be placed by the player N at the device 106 at t=3 in block J. t=3 can be any time after t=2 and/or any other times described above. t=3 can also be a same, earlier, and/or later time as any of the other times described above in reference to FIG. 3. Sometimes, the bet(s) can be placed at t=2, when the player N begins the game.

In the example of FIG. 3, the table computer 126 identifies third and fourth sets of cards that were dealt at times t=3 (when the bet(s) was placed by the player N) and t=4 (a time immediately after time t=3), respectively (block K). As described above, the table computer 126 can identify at least one set of cards that was dealt at t=3, t=2, and/or any time within some predetermined range from t=3 or t=2. The table computer 126 can then identify a first card in the third set that maps to a dice value and a second card in the fourth set that maps to a dice value (block L), as described in reference to block F. The table computer 126 determines a game outcome for player N based on at least the mapped dice values in block M (refer to block G for further discussion). Then, the table computer 126 transmits the cards with their mapped dice values and/or the game outcome to the player N′s device 106 in block N (refer to block H for further discussion).

In some implementations, the craps gaming rules can be locally stored at the device 106 and used by the device 106 to determine the game outcomes. As a result, compute resources of the table computer 126 can be more efficiently allocated for other determinations and/or processes described herein. Sometimes, the game outcome(s) can be determined and then transmitted for each stage of gameplay in blocks H and N. Sometimes, the game outcome(s) can be determined and transmitted at the end of the game in blocks H and N.

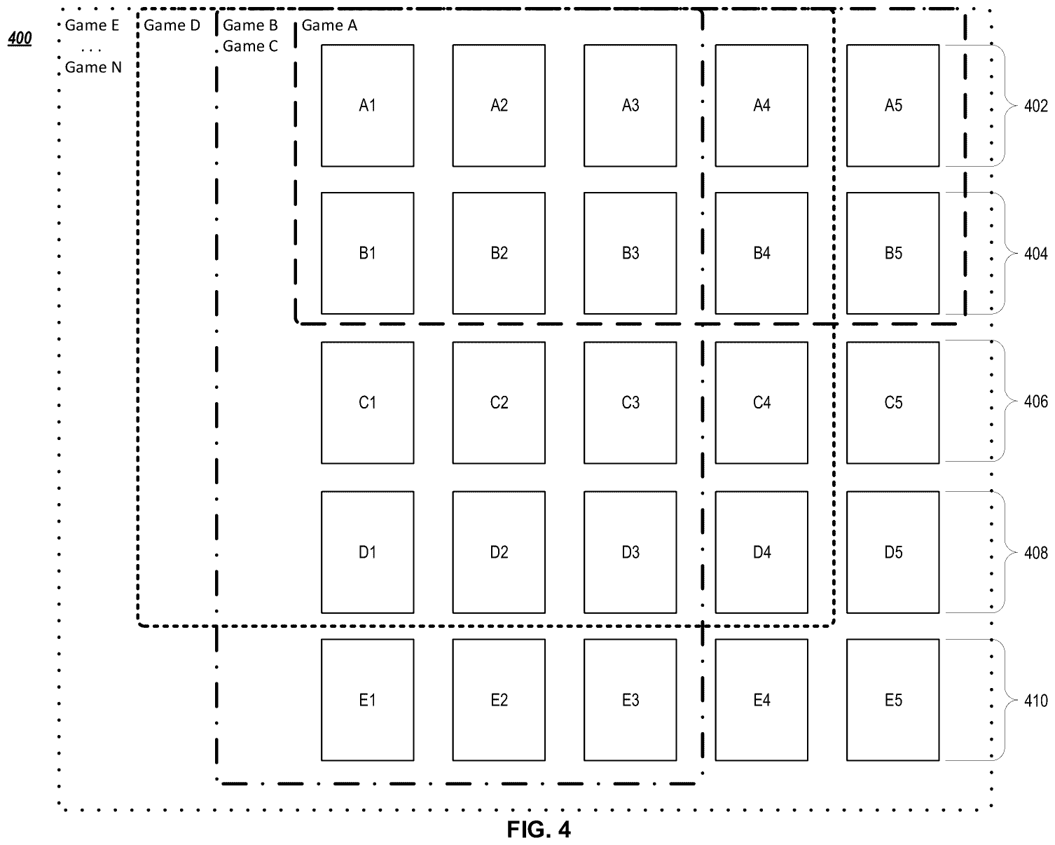

FIG. 4 depicts an example grid 400 of continuously dealt playing cards, which may be used with games such as craps described herein. Depicted in FIG. 4 are various example predefined areas, Games A-N, of the grid 400. Physical cards are dealt by a dealer (e.g., dealer 124) into the grid 400, which are then used by an electronic table computing device, such as table computer 126. In some implementations, the grid 400 is constructed based on a sequence of previously dealt and recorded cards. Each of the predefined areas of the grid 400 may be used by the table computer 126 for a particular type of game, Game A, Game B, and so forth, for which the table computer 126 provides gaming outcomes. Moreover, the cards in the grid 400 can be continuously shuffled and/or dealt, as described herein. Sometimes, all of the cards in the grid 400 can be shuffled (all 25 cards). Sets of cards can then be determined along different rows, horizontals, cross-crosses, etc. of the grid 400. This can allow for multiple games to be played in a same screen or interface (e.g., each row can represent a different game that can be played at a same time). Once the cards are shuffled, sets of the shuffled cards can then be transmitted to player devices of the players as described in above. Sometimes, fewer than all 5 sets depicted in the grid 400 can be continuously shuffled and used to generate new sets of cards.

As depicted in FIG. 4, grid 400 includes cards A1-5 in row 402, B1-5 in row 404, C1-5 in row 406, D1-5 in row 408, and E1-5 in row 410. Grid 400 is depicted as including five rows, rows 402-410, and five columns; however, any combination of rows and columns may be employed by the system to determine gaming outcomes.

In the depicted example, the table computer 126 uses cards A1-5 and B1-5 for Game A. The table computer 126 can select cards for gameplay based on card position in the grid 400. The cards A1-5 and B1-5 can also be continuously shuffled for the Game A. A player may be assigned a starting position in the grid 400 or section of the grid assigned to the particular game from which the table computer 126 may select cards. The table computer 126 may select cards sequentially or based on a step sequence (e.g., every other card) from the grid 400, starting from the starting position or based on a draw order assigned to the player or player's hand. For example, A1 may be the starting position and a step sequence of every other card being selected (e.g., A3 would be the second card selected, A5 would be the third cards selected, B2 would be the fourth card selected, and so forth). Other possible algorithms may be used to determine the initial hand and hit cards from the grid 400 for the particular game.

As an illustrative example in a game of five-card draw poker, the table computer 126 may replace A2 from a player's hand when discarded during a player's action with card B2,where card B2 was generated in the row 404 at a same or similar time as the player discarded card A2. Alternatively, the table computer 126 may provide a replacement card based on the sequential order of the row. For example, B1 would replace the first card discarded during a player action regardless of the position of the discarded card and so forth. In another alternative implementation, the table computer 126 can use a draw order for the draw cards that is assigned to each player. In a similar manner, the table computer 126 may use each predefined section of grid 400 (e.g., Games A-N) and a draw order, which may be updated between games and/or a series of games, for each predefined section to provide gaming outcomes to the player devices for each type of game supported by the table computer 126.

As an example, assuming that Game A is five-card draw poker, an outcome for each player is determined based on the final five cards in each player's hand, which, as indicated above, may be based on the Game A section of grid 400, different sets of cards that are continuously shuffled in any of the Game A-N sections of the grid 400, a draw order, each player's action, and/or timing of each player's action. In this example, a player with a pair may receive a 1:1 payout, a player with two pairs may receive a 3:2 payout, and a player with a royal flush may receive a 100:1 payout. Odds and outcomes can vary and can be determined using payout tables that correlate a hierarchy of poker hands to different payout odds. For example, the devices 104-118 and 136-138 can permit players to select a type of five-card draw poker game (e.g., Jacks or Better, Tens or Better, Deuces Wild, Bonus Poker, Double Bonus Poker) that they are playing, which can each have different payout tables that provide different odds for different types of hands. In addition to having different gaming outcomes based on the cards that players decide to discard from their initial hand, a variety of other factors can additionally determine the outcome for the player and the payout odds, such as the type of game that a player selects to play, the bet amount relative to the minimum bet denomination (e.g., max bet amount for a game can have greater odds than the minimum bet amount), the location at which the game is being played (e.g., game in bar can use payout table with different odds than standalone gaming device/table on floor of casino), the type of device on which the game is being played (e.g., standalone gaming device/table can have greater odds than gaming provided on mobile device), whether the game is part of a progressive jackpot pool (e.g., gaming devices part of a progressive pool that builds overtime until a player gets a particular type of hand(s) can have different odds than gaming devices that are not part of a progressive pool), and/or other factors.

For instance, under a Deuces Wild game, the player may not win the hand unless he/she attains a hand of three of a kind or better (with deuces being wildcards), whereas with the Jacks or Better game, the player may win the hand when he/she attains a pair of jacks or better—the payout table for these games correlates different hands within the hierarchy of poker hands to different outcomes and odds. The gaming outcome for players, and in particular the payout ratio, can depend on a bet amount and/or the location at which the game is being played (e.g., local at the table can have the highest payout, remote location within the gaming facility can have next highest payout, and remote connection outside the gaming facility can have lowest payout—other schemes are also possible). For example, many electronic games can permit a player to bet in increments of a minimum bet amount (e.g., $0.05/hand) up to a maximum bet (e.g., 5× maximum bet for maximum of $0.25/hand). However, the payout for some maximum bets (e.g., 5× bet) can be greater than the multiplier for the maximum bet. For instance, a royal flush may payout at 300:1 for a 1× bet of the minimum bet amount, whereas a royal flush may payout at 3000:1 for a 5× bet of the minimum bet amount, which is a 10× multiplier of the payout for a 5× multiplier of the bet amount.

The devices 104-118 and 136-138, the table computer 126, and/or the computer system 128 can be programmed to provide electronic gaming outcomes to the players based on the cards in grid 400 that are continuously shuffled/dealt, the predefined section of the grid 400 mapped to the current game (e.g., Games A-N), a selection algorithm that determines the initial poker hands and draw cards in an example game of poker based on, for example, a draw order; the player discard actions, the poker game selected by each player, and the bet amounts placed by each player. For instance, referring to the example grid 400 depicted in FIG. 4, the selection algorithm for a poker game may designate one of the rows of cards (e.g., row 402 with cards A1-A5) as the initial hand that provided to each player, and from which players can individually select discards. Once players have entered their discard actions, the remaining rows of cards can be dealt (e.g., deal rows 402-410) based on times at which each of the players enter their discard actions. For example, players who discard cards at time t=1 can receive cards from the row 404 as replacement cards, players who discard cards at time t=2 can receive cards from the row 406, players who discard cards at time t=3 can receive cards from the row 408, and players who discard cards at time t=4 can receive cards from the row 410. One or more other arrangements for providing cards to the players are possible.

The selection algorithm can use any of a variety of techniques to allocate draw cards from the remaining rows for each of the players, which provide for variation in which draw cards are allocated to each of the players. For example, the selection algorithm can assign different draw orders across some or all of the cards in the remaining rows to the players, such as assigning different orderings of cards within the same row (e.g., each player assigned different order of cards B1-B5 for row 404), assigning different rows of cards to each player (e.g., each player assigned one of rows 404-410), assigning different orderings of cards across different rows (e.g., each player assigned different order of cards B1-E5 for rows 404-410), and/or combinations thereof. The assignments can be automatically determined by the system and/or based on user input/selection. For instance, if the row 402 (cards A1-A5) is used to provide the initial hand, each player may be given the option to select one of the rows 404-410 (example of four remaining rows is depicted, but other numbers of rows from which players can select may be provided-such as two rows, three rows, five rows, etc.) to provide the draw order for the player. The selected row 404-410 for each player may then be (1) continuously shuffled, (2) continuously dealt, and/or (3) used to replace discards for each player using any of a variety of appropriate techniques, such as starting with a first card in the selected row and proceeding sequentially through the row (e.g., replace first discard with B1, next discard with B2, and so on), replacing each discard with a corresponding positioned card within the selected discard row (e.g., replace discard A2 with corresponding card B2 in selected row 404, replace discard A5 with corresponding card A5 in selected row 404), and/or combinations thereof. Other techniques and processes for selecting cards to replace discards are also possible.

The devices 104-118 and 136-138 can be part of a pool of gaming devices that provide progressive jackpots, which are jackpots that build over time until a player gets a particular hand (e.g., royal flush, straight flush). For example, the devices 104-118 can be part of the same progressive pool that builds over time until a player at one of those devices 104-118 gets a particular hand that wins the progressive jackpot, such as obtaining a royal flush. There can be multiple different progressive pools across different groups of gaming devices.

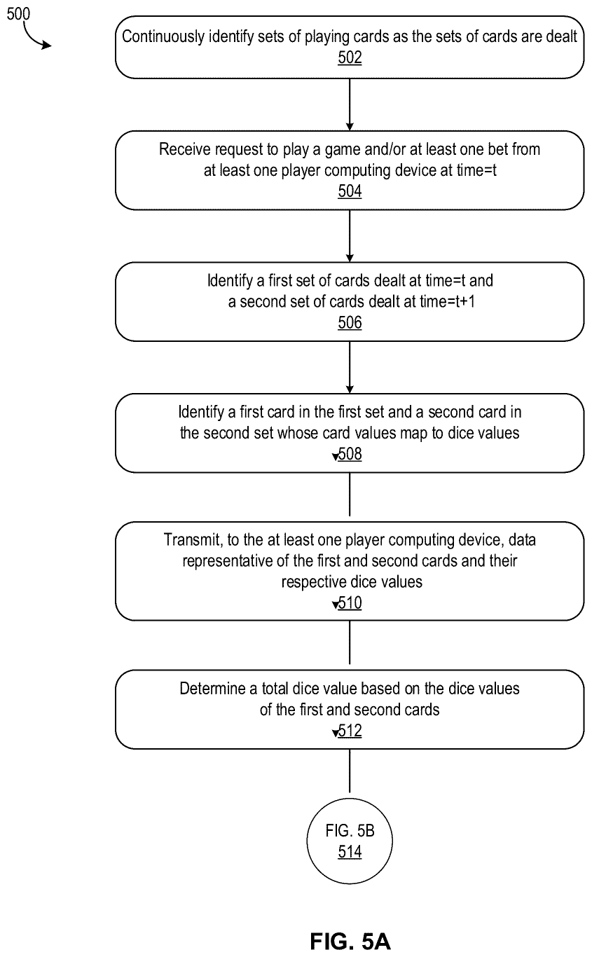

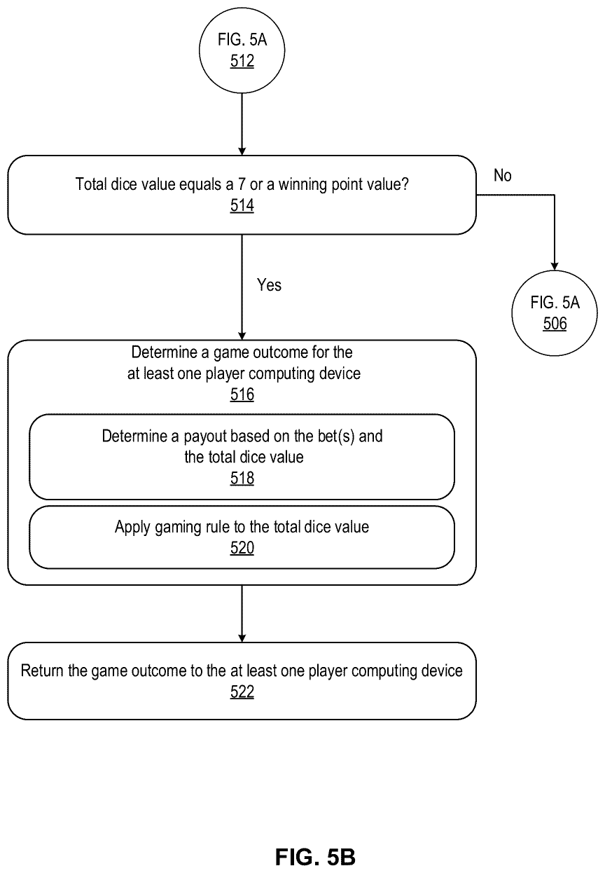

FIGS. 5A-B is a flowchart of an example technique 500 for performing card-based electronic craps gaming. The example technique 500 can be performed by any of a variety of appropriate computing equipment and/or systems, such as the table computer 126, the player computing devices 104-118 and 136-138, and the computer system 128. For illustrative purposes, the technique 500 is described from the perspective of a computer system.

Referring to the technique 500 in both FIGS. 5A-B, the computer system continuously identifies sets of playing cards as the sets of cards are dealt (block 502). For example, based on a plurality of sets of playing cards with one set of playing cards being dealt successive to another set of playing cards, the computer system can continuously identify the plurality of sets of playing cards. Physical cards that are going to be continuously shuffled and dealt across the players and their equipment as additional gameplay actions are taken, determined, and/or identified. The computer system can translate each set of playing cards into respective sets of electronic cards. As described above, the dealer can continuously shuffle cards for a duration of gameplay. The cards can be shuffled into sets, which are scanned so that the computer system can identify subsets of a set of card to be provided to the player devices 104-118 and 136-138 when the player requests to play a game of craps or otherwise places one or more bets. The table computer 126 can detect five cards (e.g., cards C1-C5) that are physically dealt by a dealer from the shoe 120 at a first time using the scanner 122. The scanner 122 can therefore identify each of the physical cards as they are dealt by the dealer at a gaming table.

In block 504, the computer system can receive a request to play or start a game and/or at least one bet, and/or side bet from at least one player computing device at time=t. The table computer 126 can receive input from the devices 104-118 and 136-138 of the players indicating that the player has joined the game, placed one or more bets, enrolled, and/or gaming balances have been removed from the players. The table computer 126 can also receive input from the devices 104-118 and 136-138 indicating a request for a dice values in a game of craps. For example, the request can include user selection of a graphical element presented in a GUI display at the at least one player computing device. The graphical element can be a selectable option to begin a game of craps. The graphical element can be a selectable option to roll 2 dice in a game of craps. The graphical element can be a selectable option to place a bet on a game of craps. Sometimes, the graphical element can be a user-selectable craps table and the player at the player computing device can provide user input to place bets on one or more portions, boxes, or fields presented as part of the user-selectable craps table. As a result, the player can place bets similarly to how they would place bets in traditional craps gameplay with a physical craps table.

Sometimes, the table computer 126 can determine whether each player is in play based on how much time has passed since the player last provided input or took some action in the game. If, for example, the player's last action was taken during a window of time that exceeds some threshold range (e.g., 10 minutes), then the table computer 126 can determine that the player is not currently in play. The player may, for example, have stepped away from their device 104-118 and 316-138 to do some other activity (e.g., get food, go to the restroom, or altogether stop playing the game).

If the table computer 126 determines that none of the players are in play, then the table computer 126 can merely continue to detect shuffled/dealt sets of cards. If at least one player is in play, then the table computer 126 can determine whether the player is starting a game or placed at least one bet on a new or current game of craps, thereby performing block 506. This determination is made based on information that is received from the devices 104-118 and 136-138. For example, each of the devices 104-118 and 136-138 can determine a stage of gameplay of each player. The devices 104-118 and 136-138 can transmit the determined stage of gameplay to the table computer 126, which the table computer 126 can use to determine whether the player is requesting initial dice values for a new game of craps. As a result, computational resources can be more efficiently used at the table computer 126 by offloading the stage determination processing to the individual player computing devices 104-118 and 136-138. In other implementations, the table computer 126, the computer system 128, or other suitable computer(s) can determine the stage of gameplay of each player.

In block 506, the computer system identifies a first set of cards among the sets of playing cards that was dealt at time=t and a second set of cards that was dealt at time=t+1. Based on the request to start a game (or place a bet), from the at least one player computing device, the computer system can identify, among the sets of playing cards being continuously identified, the first set of playing cards and the second set of playing cards. The first set of cards can represent a first dice in a game of craps and the second set of cards can represent a second dice in the game. Each of the first and second sets of playing cards can include 5 cards.

As described herein, the computer system can identify the first set of playing cards having a same timestamp or a timestamp within some threshold amount of time of a timestamp associated with the request in block 504. The second set of cards can be identified as a set of cards that were dealt immediately after the first set of cards or within some threshold amount of time of dealing the first set. Selecting the second set in such a way advantageously mimics an effect of simultaneously rolling 2 dice in a traditional game of craps.

The computer system then identifies a first card in the first set of cards and a second card in the second set of cards that have card values mapped to dice values (block 508). The computer system may associate values of the first set of playing cards with numeric values on a first dice. The computer system can also associate values of the second set of playing cards with numeric values on a second dice. The computer system can use one or more gaming rules and/or mapping data to identify which cards in the first and second sets of cards have card values that correspond to dice values. The mapping data can indicate that a subset of the card values are not mapped to dice values. For example, the subset of the card values can include a card value of King. The mapping data can also indicate that card values within a range of 1 through 6 can be mapped to dice values within a range of 1 through 6. The mapping data can also indicate that card values within a range of 7 through Queen can be mapped to dice values within a range of 1through 6. One or more other card values may also be defined in the mapping data as not being associated with dice values or otherwise being associated with different dice values, as described throughout this disclosure.

If any card in either set does not map to a dice value, then that card can be discarded from the respective set. Sometimes, that card may not be used again in subsequently dealt sets. Sometimes, that card can be shuffled into subsequently dealt sets. For example, the computer system can discard at least one card in each of the first and second sets of cards that is not mapped to a dice value. The discarded at least one card does not include the first card or the second card. Furthermore, the discarded at least one card does not have a card value that is mapped to a dice value, according to the applied mapping data.

When identifying the first and second cards, the computer system can identify a first card in a card sequence of each of the first and second sets of cards that has a card value mapped to a dice value. Therefore, even if a second card in the card sequence of the first set of cards is mapped to a dice value, the computer system selects the first card in the card sequence of the first set of cards, which is also mapped to a dice value. In some implementations, if multiple cards in a set of cards are mapped to dice values, the computer system can use randomized logic to select one of the cards in the set to be used for one of the dice values in the game of craps.

If a set of cards does not include any cards that are mapped to dice values, then the computer system can identify a subsequent set of cards (block 504) (such as a third set of cards) and identify a card in the subsequent set of cards that is mapped to a dice value (block 506). The subsequent set of cards can be dealt immediately after the second set of cards at time=t+1 or some threshold amount of time after the second set is dealt. The subsequent set of cards can be dealt at or near a time at which the computer system determines that one of the first and second sets of cards does not contain a card that is mapped to a dice value. The subsequent set of cards can be dealt and identified at one or more other times. As another illustrative example, if the first set of cards does not include any cards that are mapped to dice values, the computer system can identify another card in the second set of cards that is mapped to a dice value and provide the second card from the second set of cards as well as the another card from the second set of cards to be used as dice values for the game of craps.

In some implementations, the computer system can instead identify a single set of cards in block 506 and then identify the first and second cards in block 508 from the single set of cards. As a result, the 2 dice values for the game of craps can be identified using the single set of cards instead of 2 sets of cards. If, for example, the single set of cards only contains 1 card that is mapped to a dice value, then the computer system can identify another set of cards for use in identifying a second dice value. One or more other variations are also possible.

Still referring to the technique 500, in block 510, the computer system transmits, to the at least one player computing device, data representative of the first and second cards and their respective dice values. Refer to FIG. 1B for further discussion of the data transmitted to and displayed at the at least one player computing device. For example, the at least one player computing device can output, in a GUI display at the player computing device, (i) a graphical representation of the first card with the first dice value overlaying a portion of the graphical representation of the first card and (ii) a graphical representation of the second card with the second dice value overlaying a portion of the graphical representation of the second card. The first dice value can be displayed in a center portion of the graphical representation of the first card and an actual value of the first card can be displayed in first and second corners of the graphical representation of the first card. Similarly, the second dice value can be displayed in a center portion of the graphical representation of the second card and an actual value of the second card can be displayed in first and second corners of the graphical representation of the second card.

The computer system can determine a total dice value based on the dice values of the first and second cards (block 512). Sometimes, the computer system can determine the total dice value before block 510 and after identifying the first and second cards having their respective dice values. The computer system can determine the total dice value based on adding or summating the dice values associated with the first and second cards.

Next, the computer system can determine whether the total dice value equals a value of 7 or a winning point value in block 514. As described herein, in a game of craps, a current game ends if either the value 7 is rolled or the winning point value is rolled. The winning point value can be established as the total dice value when a new game of craps begins. As an illustrative example, if a player A begins a game of craps at time=t, their total dice value determined in block 512 can be identified as the winning point value for the current game of craps. The player A can then receive another set of dice values, which can be summated to determine whether the summation equals either the value 7 or the winning point value that was established when the player A started the game. As another example, if the player A has already been playing the game of craps, then the winning point value might have been previously established and therefore the player A's total dice value is checked against the previously-established winning point value and the value 7. In some implementations, the winning point value can be established automatically by the computer system before the player begins their game and/or before at least one player (e.g., a player at a physical gaming table or remote from the table) begins the game. The winning point value can also be established for a game using one or more other rules and/or techniques.

Still referring to block 514, if the total dice value does not equal the value 7 or the winning point value, then the computer system returns to block 506. The computer system can repeat the blocks 506-514 until all bets are reconciled (e.g., a total dice value equals the value 7 or the winning point value). If, on the other hand, the total dice value equals either the value 7 or the winning point value for the game, then the computer system proceeds to block 516.

In block 516, the computer system determines a game outcome for the at least one player computing device. For example, the computer system can determine a payout for the at least one player computing device based on the bet(s) placed by the player and the total dice value (block 518). To determine the game outcome, the computer system can apply at least one craps gaming rule to the total dice value (block 520).

The computer system can return the game outcome to the at least one player computing device in block 522.

As described herein, players that start the game at or around the same time can each receive and be presented with the same first and second cards and their corresponding dice values. The players can also place bets or make other individual game decisions at different times, and therefore receive at least one different card and the at least one different card's corresponding dice value, even if the players initially started the game together. Accordingly, the players can continue to play the game at their desired paces. Players can employ different gameplay strategies, which may also cause their timing/pacing to be different, and thus to experience different game outcomes and/or receive different dice values and craps game outcomes.

In some implementations of the technique 500, additional processes can be performed. For example, the player computing devices/equipment that are going to play a game of craps can be enrolled and debits for playing the game can be taken against gaming balances for each player. For example, the devices 104-118 and 136-138 can enroll with the table computer 126 and/or the computer system 128 to play in a next game of craps on the table 102, and a debit/ante to play the game can be taken from each player's virtual gaming balance that is maintained on devices 104-118 and 136-138, the table computer 126, and/or the computer system 128. The players can be enrolled at different times, based on whenever each of the new players desire to join or start the game.

Enrolling a new player can include, for example, the player either creating or providing player account information via the devices 104-118 and 136-138. For example, a new player may create a new player account by physically and/or electronically depositing money via the devices 104-118 and 136-138, the table computer 126, and/or the computer system 128 (e.g., feeding physical money into a bill reader that is part of/connected to the devices 104-118, providing credit/debit card information, providing bank account information). A unique account identifier can be created and funds deposited into the account can be credited to the account by the table computer 126 and/or the computer system 128, for example, as part of a ticket-in ticket-out (TITO) system. Players with preexisting accounts can provide account information via the devices 104-118 and 136-138 through one or more input mechanisms, such as through a physical ticket reader (e.g., ticket reader to read unique account identifier encoded on the ticket), through a player card reader (e.g., magnetic strip reader, RFID reader), through input of a username and password, and/or through other input mechanisms. New players can be prompted through one or more selectable options to designate a type of poker game they want to play and/or to designate a bet amount for the next craps game.

Enrolling existing players can include receiving input from the players at any point during the game. The time at which the player provides input to start a game can be used to determine which dice values the player receives, as described above. Therefore, the game can have continuous progression and players that are currently playing or wanting to start the game do not need to wait for other players to make a decision or otherwise opt in to join the game.

In some implementations, however, enrolling existing players in a next craps game can include players either providing or not providing particular types of input within a threshold amount of time for the next game to start. For example, in some instances players may opt-in to play a next game, and can be provided with a time-limited selectable option to opt-in to game play for a next craps game at a table where the player just finished a game. Failure to select the option within a threshold amount of time can cause the player to sit-out the next game. In other instances, the player may have to opt-out to avoid repeating his/her bet in a next stage of gameplay of a current game of craps, and can be provided with a time-limited selectable option to opt-out of gameplay. Failure to select the option within the threshold amount of time can cause the player to be automatically enrolled in the next stage of gameplay at the same bet amount. Other opt-in and opt-out options are also possible, such as a player designating a bet amount for a next craps stage of gameplay or new game entirely as an implicit opt-in for a game. Existing players can additionally be provided with selectable options between stages of gameplay to change the type of game that they are playing between and/or to change their bet amount.

In another example, players can similarly switch between tables upon completing a game (switch to a new table after the end of one iteration of the technique 500 and before starting another iteration of the technique 500). For example, a player can designate that he/she is ready to start another game and can select an option to be switched to another table that is starting a new game, in response to which the player electronic touchscreen can be switched to gaming with cards dealt on another table. Other options for switching between tables are also possible, such as providing input (e.g., designating a bet for the new game), the user designating that he/she is ready to play a new game, the user designating that he/she wants to be moved to another table, and/or other options.

The system 100 and, particularly, the shoe 120 can be specifically adapted to provide for efficient and repeated gaming, for example, using the technique 500. For example, the shoe 120 can be a six-deck continuous shuffle shoe such that multiple decks of cards can be shuffled together and dealt from the shoe 120. In alternative examples, the shoe 120 can include multiple decks other than six. The systems according to implementation of the present disclosure provide gaming that are amenable to using multiple decks of cards that are all shuffled together and dealt from the shoe 120, as with other types of card-based gaming, like blackjack and poker. For example, the six-deck continuous shuffle shoe 120 in the system described herein can provide for more efficient repeated game play (e.g., no need to shuffle between each game), without significantly reducing player odds, which may be more appealing to players than with conventional craps equipment. To maintain the same odds that are provided with conventional electronic craps equipment while using physical cards in a configuration that allows for efficient and repeated game play, the shoe 120 and shuffling systems (e.g., automatic shuffling machines, human shufflers) can be adapted in a couple different ways. As mentioned above, the shoe 120 can be a six-deck continuous shuffle shoe. In another example, automatic shuffling machines can be adapted to receive multiple decks of cards, with each deck of cards being separated by a physical delimiter (e.g., plastic card separator, change in card orientation). The automatic shuffling machines can then shuffle each deck separately and output a stack of randomly shuffled decks, where each deck is separated by a physical delimiter. When dealing the cards from the shoe 120, the dealer 124 can deal a preset number of cards from the first deck in the shoe 120 for the first game and then discard the remainder of the cards from the first deck (at the conclusion of the first game), then deal a preset number of cards from the second deck in the shoe 120 and then discard the remainder of the cards from the second deck, and so on until all of the decks have been dealt. By doing this, the dealer 124 can deal multiple games without having to shuffle or obtain shuffled cards for each game, which can increase the pace of gameplay, and without having to resort to using multiple decks of cards, which could lower player odds for the game.

In another example, automatic shufflers can be adapted to output a present number of cards from each deck for placement in the shoe 120 (instead of the entirety of each deck) and then the dealer 124 can simply and continuously deal games using the technique 500. By doing this, the gameplay can be made even more efficient by not requiring the dealer 124 to remove the remainder of the deck before starting a next game. This can present potential problems with keeping decks of cards separate from each other, which can be accomplished by marking cards with a unique identifier for the deck to which the card belongs (in addition to each card in a deck being marked with an identifier for the card (suit, card number)). An automatic shuffler can be programmed to receive a group of cards from mixed decks, to separate the cards into their respective decks based on the deck identifiers, and then to shuffle each deck separately from the other decks. If a deck is found to be incomplete after receiving all available cards, the cards from that deck can be discarded as being part of an incomplete deck. By doing this, the dealer 124 can more efficiently deal multiple games without having to shuffle or obtain shuffled cards for each game, which can increase the pace of gameplay, and without having to resort to using multiple decks of cards, which could lower player odds for the game.

Automatic shufflers and the system 100 can additionally and/or alternatively be adapted to continuously shuffle and use decks with greater than 52 cards, such as decks that include one or more jokers. Each table can include one or more automatic shufflers, such as tables having two, three, or more automatic shufflers to concurrently shuffle multiple decks of cards. Shufflers can be configured to output cards in groups, such as outputting sets of five cards together that can be used to perform the disclosed techniques. The automatic shufflers can accommodate one or more decks at a time.

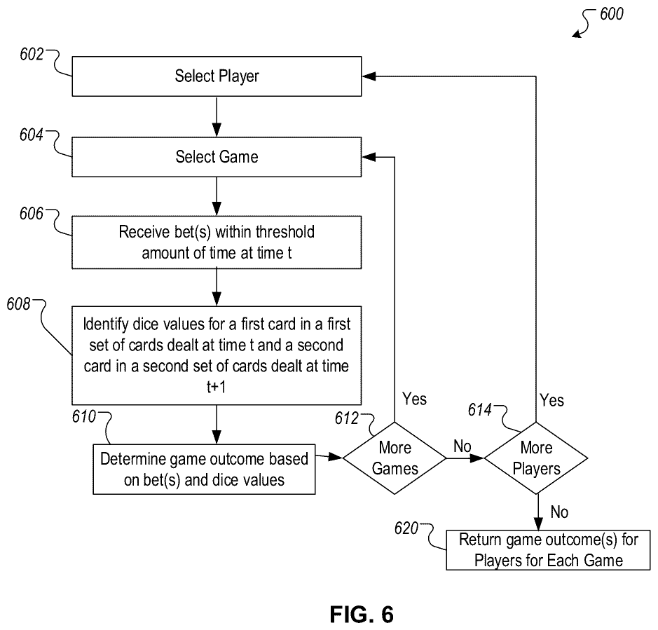

FIG. 6 is a flowchart of another example technique 600 for determining gaming outcomes for multiple games that are simultaneously played as cards are being continuously dealt. The example technique 600 can be performed by any of a variety of appropriate computing devices and/or systems, such as the table computer 126, the computing devices 104-118 and 136-138, and the computer system 128. The technique 600 can be performed, for example, as part of the technique 500 (e.g., refer to FIGS. 5A-B).

For some games, cards can be selected from a grid based on the cards each having a position that is established based on an order in which the cards were dealt. Refer to FIG. 4 for further discussion about possible card selections based on positioning in a grid. For example, in a game of craps, card A1 can be selected for a first dice value and card B1 in another grid can be selected for a second dice value. Sometimes, the first and second dice values can be identified from 2 cards in a same grid, such as 2 of the cards A1-5.

For some types of games that require draw cards (e.g., draw poker), the cards selected for a player can be viewed as each having a position that is established based on the order in which the draw cards were selected (e.g., the cards order in the grid) or based on an order assigned to the cards for the player. When draw cards are read from the same grid or grid section, the starting position in the grid for reading the draw card can be the next sequential card after the last card selected. When the draw cards are read from another grid than the cards read, the starting position in the other grid for reading the draw card can be the first card in the other grid or section of the other grid allocated to the particular game for which the cards are being selected. Draw cards can be selected by sequentially progressing through the remaining cards in the grid or grid section to fill the open spots in each player's hand resulting from player discards from their initial hand. For example, referring to grid 400 in FIG. 4, if cards A1-5 were used as players' initial hands in a game of poker, the next sequential positon would be B1. A first player who discarded two cards at a first time, will receive the next two sequential cards in the grid, B1 and B2. A second player who discarded three cards at the same time will receive the cards B1, B2, and B3. On the other hand, if the second player discarded three cards at a different time, then the second player can receive cards that were dealt in the grid at the different time. For example, the cards C1, C2, and C3 can be dealt at the same time or around the same time that the second player discarded three cards. Thus, the second player can receive the cards C1, C2, and C3 instead of the cards B1, B2, and B3, which were dealt at a different time.

As part of the technique 600, a player who is playing (either physically or virtually) at a table is selected (block 602). A game played by the selected player is selected (block 604), such as craps (although other games can also be selected as described above), followed by receiving (block 606) at least one bet within a threshold amount of time at time t. Dice values for a first card in a first set of cards dealt at time t and a second card in a second set of cards dealt at time t+1 are identified (block 608), and a game outcome is determined for the selected player based on the bet(s) and dice values (block 610). Refer to the technique 500 in FIGS. 5A-B for further discussion about performing blocks 606-610.

The blocks 606-610 can be repeated until the current game naturally ends or otherwise the player's bets are reconciled.

Once the current game ends, in block 612, a check is done as to whether the selected player is playing more than one game. If there are more games for that player, then blocks 604-610 are repeated for each game. If the player is not playing more games, then block 614 is performed.

In block 614, a check is performed as to whether there are more players physically and/or virtually playing at the table still playing the game of craps (or another game). If there are more players, blocks 602-612 are repeated for each remaining player. Once the blocks 602-612 are performed, game outcomes for the players for each game can be returned in block 620, if they have not already been returned to the players.

Sometimes, any one or more blocks in the technique 600 can be performed simultaneously. For example, one or more of the blocks 604-614 can be simultaneously performed for each player playing one or more games at a same or similar time. Sometimes, one or more other rows in the grid 400 can be used to provide game outcomes to the players that are at different stages of gameplay at one or more different times. Thus, the entire grid 400 may be used for a game of craps, as described herein. As an illustrative example, the cards in row A1-5 may be used to identify first and second dice values for a first player and cards in any of the other rows in the grid 400 can be used to identify first and second dice values for a second, third, fourth, etc., player in the game of caps. Various other implementations are also possible.

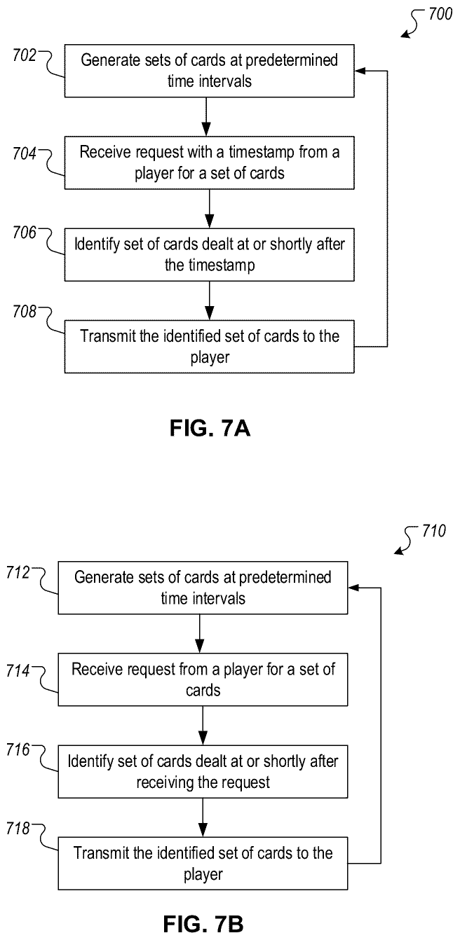

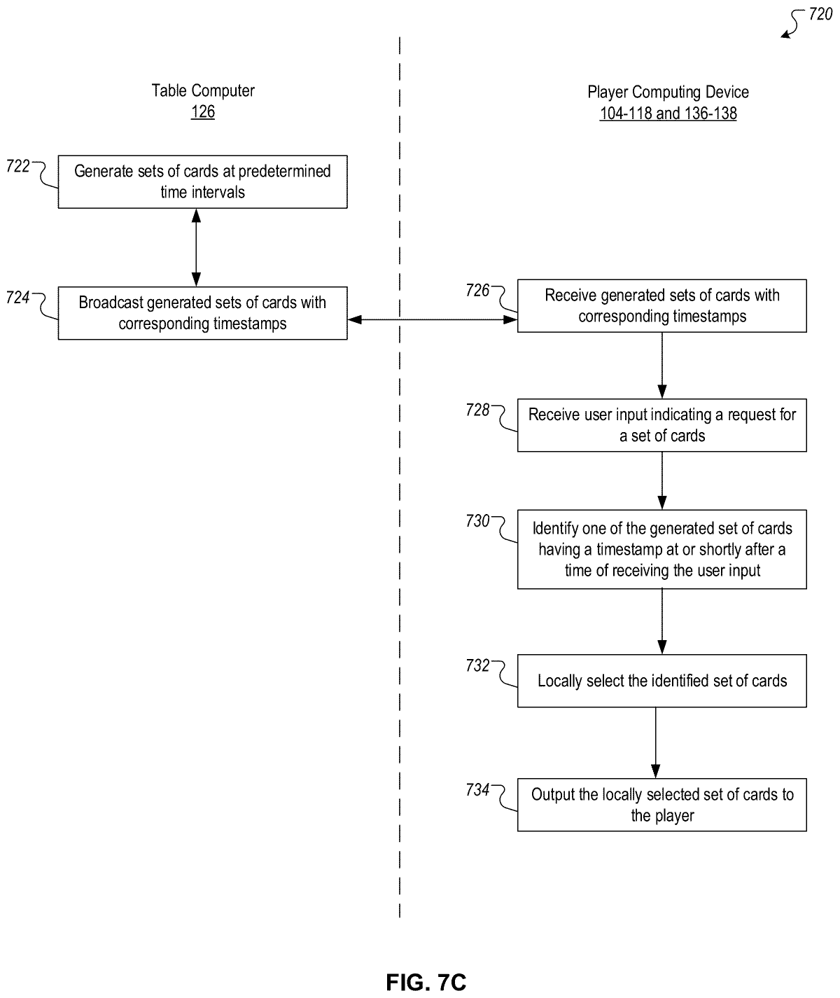

FIGS. 7A-C are flowcharts of example techniques 700, 710, and 720 for transmitting sets of cards to player computing devices. The techniques 700, 710, and 720 can be used to maximize output in terms of numbers of cards being played in a period of time. The example techniques 700, 710, and 720 can be performed by any of a variety of appropriate computing devices and/or systems, such as the table computer 126, the computing devices 104-118 and 136-138, and the computer system 128. The techniques 700, 710, and 720 can be performed, for example, as part of the techniques 500 and/or 600 (e.g., refer to FIGS. 5-6).

Referring to the technique 700 in FIG. 7A, sets of cards can be generated at predetermined time intervals (block 702). As described above in reference to FIGS. 1-3, the dealer (such as the dealer 124) can continuously deal sets of cards at the dealer's desired pace (e.g., as quickly as the dealer can deal and scan sets of cards). Each set of cards that is generated can include a timestamp indicating a time at which the set is generated and/or scanned by the scanner 122. Sometimes, the timestamp can be a relative timing that takes into consideration a time when the cards are physically dealt and a time at which the cards are scanned and registered by the table computer 126. Sets of cards can be continuously generated and scanned throughout the technique 700.

The table computer 126 can receive a request from a player device for a set of cards (e.g., initial first and second hands in baccarat, one or more hit cards) (block 704). The request can include a timestamp. The timestamp can indicate a time at which the player performed some action in the game, such as selecting an option to begin a new game, placing a bet on either initial first and second hands, or requesting one or more hit cards. The timestamp can also indicate a time at which the request for the set of cards is transmitted and/or received by the table computer 126.

The table computer 126 can then identify a set of cards that were dealt (block 702) at or shortly after the timestamp in the request (block 706). For example, the table computer 126 can determine which set of cards has been dealt within a predetermined threshold time range from the timestamp in the request. The table computer 126 can compare a timestamp of each set of dealt cards with the timestamp in the request. A set of cards having the same timestamp can be selected (block 706). In some implementations, a set of cards having a timestamp within a threshold amount of time after the timestamp in the request can be identified. In other implementations, a set of cards having a timestamp within a threshold amount of time before the timestamp in the request can be identified. In yet some implementations, if the timestamp in the request falls within the timestamps of a first set of cards and a second set of cards, the second set of cards can be selected to enhance game security (e.g., to ensure that no player has an upper hand or advantage on other players in the game). If game security would be unaffected by selection of a set of cards, then the first set of cards can be selected in order to increase pace of gameplay.

Moreover, in some implementations, selection of a set of cards can be based on decisions made based on timing of decisions that are made by a player, rather than the timestamp in the request. For example, if the player makes a decision prior to a fifth card in a current set of cards being drawn, then the player would receive at least one card from that current set of five cards. If the player makes a decision after the timestamp of the fifth card in the current set of cards that are being drawn, then the player would receive at least one card from a next set of five cards that are drawn by the dealer. After the set of cards are selected in block 706, the table computer 126 can transmit the identified set of cards to the player (block 708).

Referring to the technique 710 in FIG. 7B, sets of cards can be generated at predetermined time intervals (block 712). Refer to block 702 in the technique 700 depicted in FIG. 7A. The table computer 126 can receive a request from a player device for a set of cards (block 714). The request may not include a timestamp. Accordingly, unlike the technique 700, the table computer 126 can identify a set of cards that were dealt at or shortly after receiving the request (block 716). The table computer 126 can then transmit the identified set of cards (or a subset of the identified set of cards) to the player's device (block 718).

Referring to the technique 720 in FIG. 7C, sets of cards can be generated at predetermined time intervals (block 722). As described in reference to FIG. 7A, the dealer can continuously deal sets of cards, which can be scanned by the scanner and detected or otherwise registered by the table computer 126. The table computer 126 can then broadcast the sets of cards with corresponding timestamps (block 724). The table computer 126 can broadcast each set of cards as they are generated. Other times, the table computer 126 can broadcast sets of cards in batches (e.g., broadcast 2 sets of cards at a time, where each set has a different timestamp indicating when they were generated). The sets can be broadcasted to all player computing devices 104-118 and 136-138, regardless of whether players are actually playing the games at such devices. Sometimes, the sets can be broadcasted only to those devices 104-118 and 136-138 where players are currently playing the game. For example, the table computer 126 can receive notifications from the devices 104-118 an 136-138 that indicate that a player has started a game or taken some action in a game. The table computer 126 can then broadcast the sets of cards to only those devices.

The player computing devices 104-118 and 136-138 can receive the generated sets of cards with their corresponding timestamps (block 726). The devices 104-118 and 136-138 can also receive user input indicating a request for a set of cards (block 728). The user input can be some action that is taken in the game by the player. For example, the player can select an option to start a game, which can be user input indicating that player user needs initial first and second hands of cards. The player can also place one or more bets on current initial first and second hands, which can be user input indicating that gaming outcomes may be determined and/or hit cards may be identified and assigned.

Sometimes, the user input can be received before one or more of the generated sets of cards are received. Sometimes, the user input can be received at a same time as one or more of the generated sets of cards. Moreover, as described above, the devices 104-118 and 136-138 can continuously receive the generated sets of cards, regardless of when the devices 104-118 and 136-138 receive user input indicating a request for a set of cards.

The devices 104-118 and 136-138 can identify one of the generated sets of cards having a timestamp that is at or shortly after a time that the devices received the user input (block 730). For example, the devices 104-118 and 136-138 can temporarily store the sets of cards that are broadcasted by the table computer 126 in 724 and received in 726. The devices 104-118 can look at the timestamps for each of the sets of cards in temporary storage and determine which timestamp falls within some predetermined threshold range of time from the time of the request for a set of cards. A set of cards that were dealt at a same time as the request can be identified. A set of cards that were dealt within a threshold amount of time after the request was received can be identified. In some implementations, a set of cards that were dealt within a threshold amount of time before the request was received can be identified.

The devices 104-118 and 136-138 can then locally select the identified set of cards (block 732). Performing blocks 730-732 at each of the devices 104-118 and 136-138 can be advantageous to more efficiently utilize computational resources, especially at the table computer 126. The table computer 126 can then operate more efficiently and quickly since it does not have to determine, for each player, which set of cards each device 104-118 and 136-138 should receive.

Finally, the devices 104-118 and 136-138 can output the locally selected set of cards (or a subset of the locally selected set of cards) to the player (block 734). The player can then take some action in the game based on their updated hand, and the blocks 722-734 can be repeated until the game ends/one of the first and second hands wins.

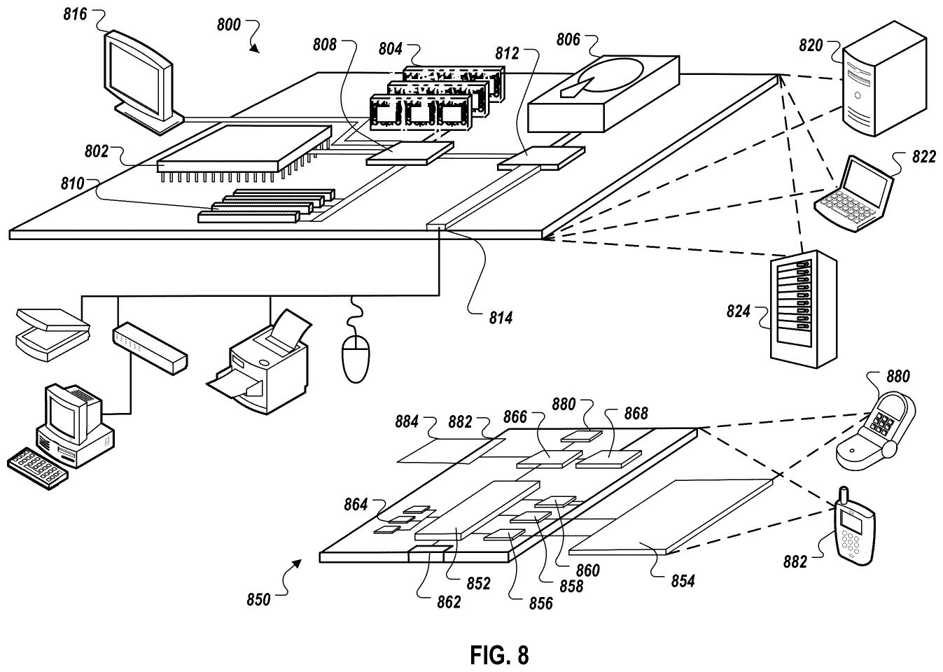

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation-and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. An electronic gaming system using common playing cards, the system comprising:
a plurality of player computing devices that are configured to provide individualized gaming interfaces for a plurality of players; and
a gaming computing device that is in communication with the plurality of player computing devices, the gaming computing device configured to:
based on a plurality of sets of playing cards with one set of playing cards being dealt successive to another set of playing cards, continuously identify the plurality of sets of playing cards;
based on a request to start a game from at least one of the plurality of player computing devices, identify, among the plurality of sets of playing cards being continuously identified, a first set of playing cards and a second set of playing cards;
identify, among the first set of playing cards, a first card having a card value that is mapped, based on mapping data, to a first dice value, the mapping data indicating a mapping of card values to dice values;
identify, among the second set of playing cards, a second card having a card value that is mapped, based on the mapping data, to a second dice value;
transmit, to the at least one of the plurality of player computing devices, data representative of the first card, the second card, the first dice value, and the second dice value;
determine an outcome of the game being played at the at least one of the plurality of player computing devices based on applying a gaming rule to a summation of the first dice value and the second dice value; and
return the outcome of the game to the at least one of the plurality of player computing devices.

2. The electronic gaming system of claim 1, further comprising:
a plurality of physical playing cards that are physically dealt by a dealer;
a scanner that is configured to identify each of the playing cards as they are dealt by the dealer, wherein the scanner is in communication with the gaming computing device; and
a plurality of gaming tables, wherein each of the plurality of gaming tables allows the dealer to deal the physical playing cards,
wherein the scanner is configured to read one or more of the physical playing cards for the gaming table.

3. The electronic gaming system of claim 2, wherein at least one of the plurality of player computing devices is physically located at at least one of the plurality of gaming tables or is physically remote from a location of the at least one of the plurality of gaming tables.

4. The electronic gaming system of claim 1, wherein the gaming computing device is further configured to provide, in graphical user interface (GUI) displays of the at least one of the plurality of player computing devices, selectable options to play multiple different games simultaneously with the plurality of sets of playing cards that are being continuously identified.

5. The electronic gaming system of claim 1, wherein the request includes user selection of a graphical element presented in a graphical user interface (GUI) display at the at least one of the plurality of player computing devices.

6. The electronic gaming system of claim 5, wherein the graphical element is a selectable option to roll two dice in a game of craps.

7. The electronic gaming system of claim 5, wherein the graphical element is a selectable option to place a bet on a game of craps.

8. The electronic gaming system of claim 1, wherein the gaming computing device is configured to:
associate values of the first set of playing cards with numeric values on a first dice; and
associate values of the second set of playing cards with numeric values on a second dice.

9. The electronic gaming system of claim 1, wherein the first set of playing cards represent a first dice and the second set of playing cards represent a second dice.

10. The electronic gaming system of claim 1, wherein the at least one of the plurality of player computing devices is configured to:
output, in a graphical user interface (GUI) display at the at least one of the plurality of player computing devices, a graphical representation of a craps table;
receive user input indicating selection of a portion of the graphical representation of the craps table during gameplay; and
transmit, to the gaming computing device, the user input as the request.

11. The electronic gaming system of claim 1, wherein, based on receiving the data representative of the first card, the second card, the first dice value, and the second dice value, the at least one of the plurality of player computing devices is configured to output, in a GUI display at the at least one of the plurality of player computing devices, (i) a graphical representation of the first card with the first dice value overlaying a portion of the graphical representation of the first card and (ii) a graphical representation of the second card with the second dice value overlaying a portion of the graphical representation of the second card.

12. The electronic gaming system of claim 11, wherein:
the first dice value is displayed in a center portion of the graphical representation of the first card and an actual value of the first card is displayed in first and second corners of the graphical representation of the first card, and
the second dice value is displayed in a center portion of the graphical representation of the second card and an actual value of the second card is displayed in first and second corners of the graphical representation of the second card.

13. The electronic gaming system of claim 1, wherein:
identifying, among the first set of playing cards, a first card comprises identifying the first card in a card sequence of the first set of playing cards having a card value that is mapped to a dice value in the mapping data, and
identifying, among the second set of playing cards, a second card comprises identifying the second card in a card sequence of the second set of playing cards having a card value that is mapped to a dice value in the mapping data.

14. The electronic gaming system of claim 13, wherein, in response to determining that none of the cards in the first set of playing cards has a card value that is mapped to a dice value in the mapping data:
identifying a third set of playing cards among the plurality of sets of playing cards being continuously identified;
identifying, among the third set of playing cards, a first card;
determining a first dice value for the first card in the third set of playing cards based on the mapping data; and
transmitting, to the at least one of the plurality of player computing devices, data representative of the first card in the third set of playing cards and the first dice value for the first card in the third set of playing cards.

15. The electronic gaming system of claim 14, wherein the gaming computing device is further configured to:
determine the outcome of the game being played at the at least one of the plurality of player computing devices based on applying a gaming rule to a summation of the first dice value for the first card in the third set of playing cards and the second dice value for the second card in the second set of playing cards; and
transmit, to the at least one of the plurality of player computing devices, data representative of the outcome to be presented in a GUI display at the at least one of the plurality of player computing devices.

16. The electronic gaming system of claim 13, wherein, in response to determining that none of the cards in the first set of playing cards has a card value that is mapped to a dice value in the mapping data:
identifying, among the second set of playing cards, a first card;
determining a first dice value for the first card in the second set of playing cards based on the mapping data; and
transmitting, to the at least one of the plurality of player computing devices, data representative of the first card in the second set of playing cards and the first dice value for the first card in the second set of playing cards.

17. The electronic gaming system of claim 13, wherein, in response to determining that none of the cards in the second set of playing cards has a card value that is mapped to a dice value in the mapping data:
identifying a third set of playing cards among the plurality of sets of playing cards being continuously identified;
identifying, among the third set of playing cards, a second card;
determining a second dice value for the second card in the third set of playing cards based on the mapping data; and
transmitting, to the at least one of the plurality of player computing devices, data representative of the second card in the third set of playing cards and the second dice value for the second card in the third set of playing cards.

18. The electronic gaming system of claim 13, wherein, in response to determining that none of the cards in the second set of playing cards has a card value that is mapped to a dice value in the mapping data:
identifying a fourth set of playing cards among the plurality of sets of playing cards being continuously identified;
identifying, among the fourth set of playing cards, a second card;
determining a second dice value for the second card in the fourth set of playing cards based on the mapping data; and
transmitting, to the at least one of the plurality of player computing devices, data representative of the second card in the fourth set of playing cards and the second dice value for the second card in the fourth set of playing cards.

19. The electronic gaming system of claim 18, wherein the gaming computing device is further configured to:
determine the outcome of a game being played at the at least one of the plurality of player computing devices based on applying a gaming rule to a summation of the first dice value for the first card in the first set of playing cards and the second dice value for the second card in the fourth set of playing cards; and
transmit, to the at least one of the plurality of player computing devices, data representative of the outcome to be presented in a GUI display at the at least one of the plurality of player computing devices.

20. The electronic gaming system of claim 1, wherein applying a gaming rule to a summation of the first dice value and the second dice value comprises:
determining whether the summation equals a value of 7 or a winning point value for the game; and
determining that the game ended based on the summation equaling the value of 7 or the winning point value for the game.
